(19) United States
(12) Patent Application Publication
(10) Pub. No.: US 2025/0377506 A1
(43) Pub. Date: Dec. 11, 2025

(54) FIBER OPTIC BACKPLANE CONNECTION SYSTEM, BACKPLANE CONNECTOR ASSEMBLY, AND BACKPLANE ADAPTER ASSEMBLY

(71) Applicant: Senko Advanced Components, Inc., Hudson, MA (US)

(72) Inventor: Siu Kei MA, Kowloon (HK)

(21) Appl. No.: 19/233,172

(22) Filed: Jun. 10, 2025

Related U.S. Application Data
(60) Provisional application No. 63/658,867, filed on Jun. 11, 2024.
(60) Provisional application No. 63/719,083, filed on Nov. 11, 2024.

(51) Int. Cl. G02B 6/38

(52) U.S. Cl. CPC G02B 6/3825; G02B 6/3831; G02B 6/3893

(57) ABSTRACT

In a fiber optic backplane connection system, a backplane adapter assembly has a fiber optic adapter supported on a panel. The fiber optic adapter defines a plurality of connector ports arranged in a row. In a backplane connector assembly, a multi-connector chassis is mounted on a module body and is movable in relation to panel and the backplane adapter assembly along a z-axis. A plurality of push-pull fiber optic connectors are mounted on the multi-connector chassis and mateable with the connector ports. The multi-connector chassis holds the push-pull fiber optic connectors on the module body such that the push-pull fiber optic connectors are all simultaneously blind mated with the connector ports of the fiber optic adapter by the module body moving backward from the first position and the second position. Floating movement between the push-pull fiber optic connectors and the fiber optic adapter is permitted.

### CROSS-REFERENCE TO RELATED APPLICATIONS

This application claims priority to U.S. Provisional Patent Application Nos. 63/719,083 and 63/658,867, each of which is hereby incorporated by reference in its entirety.

### FIELD

This disclosure generally pertains to blind mate fiber optic backplane connection systems, fiber optic backplane connector assemblies, and fiber optic backplane adapter assemblies.

### BACKGROUND

The field of high-performance computing, artificial intelligence, and data center infrastructure is experiencing an exponential increase in demand for data processing and communication bandwidth. Modern electronic systems, such as network switches, routers, and server clusters, commonly employ modular architectures with functional modules, like line cards or accelerator cards, which are removably inserted into a chassis and interconnected via a system backplane. As data rates increase, traditional electrical backplane interconnects face limitations, driving a shift towards high-density optical communication pathways between modules and the backplane. These optical interfaces typically require robust blind mate connector systems to ensure reliable alignment and connection as modules are inserted or removed during deployment or service. However, achieving ever-higher interconnect density, maintaining signal integrity, ensuring mechanical robustness, managing thermal loads, and facilitating efficient serviceability for these critical blind-mate optical backplane connections present significant and ongoing challenges for system designers striving to meet the performance and scalability demands of next-generation data processing systems.

### SUMMARY

In one aspect, a fiber optic backplane connection system comprises a backplane adapter assembly comprising a fiber optic adapter supported on a panel extending in a plane parallel to an x-axis and a y-axis of the fiber optic backplane connection system. The fiber optic adapter comprises a plurality of connector ports arranged in a row along the y-axis. A backplane connector assembly comprises a multi-connector chassis mounted on a module body such that the multi-connector chassis moves substantially with the module body in relation to the panel and the backplane adapter assembly. The module body is movable in relation to panel and the backplane adapter assembly along a z-axis of the backplane connection system between a first position and a second position. A plurality of push-pull fiber optic connectors are mounted on the multi-connector chassis. Each of the push-pull fiber optic connectors is configured to mate with one of the connector ports. The multi-connector chassis holds the push-pull fiber optic connectors on the module body such that the push-pull fiber optic connectors are all simultaneously blind mated with the connector ports of the fiber optic adapter by the module body moving backward from the first position and the second position. The fiber optic backplane connection system is configured to permit relative floating movement between the plurality of push-pull fiber optic connectors and the fiber optic adapter as the module body moves from the first position and the second position to simultaneously blind mate all the push-pull fiber optic connectors into the connector ports of the fiber optic adapter.

In another aspect, a backplane connector assembly for a fiber optic backplane connection system comprises a multi-connector chassis comprising a base configured to be fastened on a module body such that the multi-connector chassis moves substantially with the module body in relation to a panel and a backplane adapter assembly supported on the module body. The multi-connector chassis further comprises a cradle portion on the base. The cradle portion defines a plurality of connector retainers arranged in a line along a y-axis of the fiber optic backplane connection system. The cradle portion defines first and second end walls. A plurality of push-pull fiber optic connectors are mounted on the multi-connector chassis. Each of the push-pull fiber optic connectors is configured to mate with one of a plurality of connector ports of a fiber optic adapter of the backplane adapter assembly. Each push-pull fiber optic connector comprising a fiber optic ferrule, a ferrule holder, and a pullback extraction mechanism configured to be pulled backward in relation to the ferrule holder. Each push-pull fiber optic connector is configured to latch with the fiber optic adapter when the push-pull fiber optic connector is mated with the respective connector port and wherein the pullback extraction mechanism is configured to unlatch the push-pull fiber optic connector from the connector port. Each pullback extraction mechanism is retained in a respective one of the connector retainers such that the pullback extraction mechanisms are movable with the multi-connector chassis in relation to the ferrule holders such that the push-pull fiber optic connectors can all be simultaneously unlatched from the fiber optic adapter by pulling the multi-connector chassis backward. A cover is supported on the first and second end walls and fastened to the multi-connector chassis to secure the plurality of push-pull fiber optic connectors in the cradle portion.

In another aspect, a backplane adapter assembly for a fiber optic backplane connection system comprises a fiber optic adapter configured to be supported on a panel extending in a plane parallel to an x-axis and a y-axis of the fiber optic backplane connection system. The fiber optic adapter comprises a plurality of connector ports arranged in a row along the y-axis. Each of the connector ports is configured to mate with one of a plurality of push-pull fiber optic connectors of a backplane connector assembly. An adapter collar is secured to the panel and surrounding the fiber optic adapter. The adapter collar is configured to be received in a receptacle of the back plane connector assembly surrounding the plurality of push-pull fiber optic connectors. The adapter collar defines a plurality of cantilevered guide fingers protruding beyond the fiber optic adapter and configured to be received to guide the adapter collar into the receptacle and guide fiber optic adapter to mate with the push-pull fiber optic connectors.

Other aspects will be in part apparent and in part pointed out hereinafter.

### BRIEF DESCRIPTION OF THE DRAWINGS

FIG. 1 is a schematic illustration of a rack space in a modern high-density data processing system;

FIG. 2 is a perspective of a backplane connection system;

FIG. 3 is another perspective of the backplane connection system;

FIG. 4 is another perspective of the backplane connection system;

FIG. 5 is an exploded perspective of the backplane connection system;

FIG. 6 is an elevation of a multi-connector chassis of the backplane connection system;

FIG. 7 a plan view of the multi-connector chassis;

FIG. 8 is a perspective of the multi-connector chassis;

FIG. 9 is a cross-sectional perspective of the multi-connector chassis;

FIG. 10 is a perspective of a cover of the backplane connection system;

FIG. 11 is a plan view of the cover;

FIG. 12 is another perspective of the cover;

FIG. 13 is a perspective of a collar of the backplane connection system;

FIG. 14 is another perspective of the collar;

FIG. 15 is a perspective showing a backplane connector assembly of the backplane connection system approaching a backplane adapter assembly of the backplane connection system for mating;

FIG. 16 is a perspective similar to FIG. 15 showing the backplane connector assembly further advanced;

FIG. 17 is a perspective similar to FIG. 16 showing the backplane connector assembly further advanced;

FIG. 18 is a perspective similar to FIG. 17 showing the backplane connector assembly mated with the backplane adapter assembly;

FIG. 19 is a cross-sectional perspective of the scene in FIG. 15;

FIG. 20 is a cross-sectional perspective of the scene in FIG. 16;

FIG. 21 is a cross-sectional perspective of the scene in FIG. 17;

FIG. 22 is a cross-sectional perspective of the scene in FIG. 18;

FIG. 23 is another perspective of the backplane connector assembly mated with the backplane adapter assembly;

FIG. 24 is a perspective similar to FIG. 23 showing the backplane connector assembly in a partially extracted state;

FIG. 25 is a perspective similar to FIG. 24 showing the backplane connector assembly fully extracted;

FIG. 26 is a cross-sectional perspective of the scene in FIG. 23;

FIG. 27 is a cross-sectional perspective of the scene in FIG. 24

FIG. 28 is a cross-sectional perspective of the scene in FIG. 25;

FIG. 29 is a perspective of a guide plate of the backplane connection system;

FIG. 30 is a plan view of the guide plate;

FIG. 31 is a perspective of another embodiment of a backplane connection system;

FIG. 32 is another perspective of the backplane connection system of FIG. 31;

FIG. 33 is another perspective of the backplane connection system of FIG. 31;

FIG. 34 is another perspective of the backplane connection system of FIG. 31;

FIG. 35 is an exploded perspective of the backplane connection system of FIG. 31;

FIG. 36 is a perspective of a multi-connector chassis of the backplane connection system of FIG. 31;

FIG. 37 is a perspective of a back body of the backplane connection system of FIG. 31;

FIG. 38 is another perspective of the back body;

FIG. 39 is a perspective of a cover of the backplane connection system of FIG. 31;

FIG. 40 is another perspective of the cover of FIG. 39;

FIG. 41 is an elevation of the cover of FIG. 39;

FIG. 42 is another elevation of the cover of FIG. 39;

FIG. 43 is a perspective showing a backplane connector assembly of the backplane connection system of FIG. 39 approaching a backplane adapter assembly of the backplane connection system of FIG. 39 for mating;

FIG. 44 is a perspective similar to FIG. 43 showing the backplane connector assembly further advanced;

FIG. 45 is a perspective similar to FIG. 44 showing the backplane connector assembly further advanced;

FIG. 46 is a perspective similar to FIG. 45 showing the backplane connector assembly mated with the backplane adapter assembly;

FIG. 47 is a cross-sectional perspective of the scene in FIG. 43;

FIG. 48 is a cross-sectional perspective of the scene in FIG. 44;

FIG. 49 is a cross-sectional perspective of the scene in FIG. 45;

FIG. 50 is a cross-sectional perspective of the scene in FIG. 46;

FIG. 51 is another perspective of the backplane connector assembly of FIG. 43 mated with the backplane adapter assembly of FIG. 43;

FIG. 52 is a perspective similar to FIG. 51 showing the backplane connector assembly in a partially extracted state;

FIG. 53 is a perspective similar to FIG. 52 showing the backplane connector assembly fully extracted;

FIG. 54 is a cross-sectional perspective of the scene in FIG. 51;

FIG. 55 is a cross-sectional perspective of the scene in FIG. 52;

FIG. 56 is a cross-sectional perspective of the scene in FIG. 53;

FIG. 57 is perspective of another embodiment of a backplane connection system;

FIG. 58 is another perspective of the backplane connection system of FIG. 57;

FIG. 59 is another perspective of the backplane connection system of FIG. 57;

FIG. 60 is another perspective of the backplane connection system of FIG. 57;

FIG. 61 is an exploded perspective of the backplane connection system of FIG. 57;

FIG. 62 is a perspective showing a backplane connector assembly of the backplane connection system of FIG. 57 approaching a backplane adapter assembly of the backplane connection system of FIG. 57 for mating;

FIG. 63 is a perspective similar to FIG. 62 showing the backplane connector assembly further advanced;

FIG. 64 is a perspective similar to FIG. 63 showing the backplane connector assembly further advanced;

FIG. 65 is a perspective similar to FIG. 64 showing the backplane connector assembly mated with the backplane adapter assembly;

FIG. 66 is a cross-sectional perspective of the scene in FIG. 62;

FIG. 67 is a cross-sectional perspective of the scene in FIG. 63;

FIG. 68 is a cross-sectional perspective of the scene in FIG. 64;

FIG. 69 is a cross-sectional perspective of the scene in FIG. 65;

FIG. 70 is another perspective of the backplane connector assembly of FIG. 57 mated with the backplane adapter assembly of FIG. 57;

FIG. 71 is a perspective similar to FIG. 70 showing the backplane connector assembly in a partially extracted state;

FIG. 72 is a perspective similar to FIG. 71 showing the backplane connector assembly fully extracted;

FIG. 73 is a cross-sectional perspective of the scene in FIG. 70;

FIG. 74 is a cross-sectional perspective of the scene in FIG. 71;

FIG. 75 is a cross-sectional perspective of the scene in FIG. 72;

FIG. 76 is a perspective of another embodiment of a backplane connection system;

FIG. 77 is another perspective of the backplane connection system of FIG. 76;

FIG. 78 is an exploded perspective of the backplane connection system of FIG. 76;

FIG. 79 is an enlarged fragmentary perspective showing a backplane connector assembly of the backplane connection system of FIG. 76;

FIG. 80 is a cross-sectional perspective of the scene in FIG, 79;

FIG. 81 is another cross-sectional perspective of the backplane connector assembly of FIG. 79;

FIG. 82 is an enlarged fragmentary perspective of a backplane adapter assembly of the backplane connection system of FIG. 76;

FIG. 83 is a cross-sectional perspective of the backplane adapter assembly of FIG. 82;

FIG. 84 is a perspective of the backplane connection system of FIG. 76 showing fiber optic connectors before being loaded into a multi-connector chassis while the backplane connector assembly is extracted;

FIG. 85 is a perspective similar to FIG. 84 showing the fiber optic connectors after they are loaded but before a cover is placed on the multi-connector chassis;

FIG. 86 is a perspective similar to FIG. 85 showing the cover installed and the backplane connector assembly being inserted toward the backplane adapter assembly;

FIG. 87 is a perspective similar to FIG. 86 showing the backplane connector assembly fully inserted;

FIG. 88 is a perspective similar to FIG. 87 showing the backplane connector assembly being extracted from a mated configuration;

FIG. 89 is a perspective similar to FIG. 89 showing the backplane connector assembly extracted;

FIG. 90 is a perspective of another embodiment of a backplane connection system;

FIG. 91 is a plan view of the backplane connection system of FIG. 90;

FIG. 92 is another perspective of the backplane connection system of FIG. 90;

FIG. 93 is another perspective of the backplane connection system of FIG. 90;

FIG. 94 is an elevation of the backplane connection system of FIG. 90 showing a backplane connector assembly thereof being inserted into a backplane adapter assembly thereof;

FIG. 95 is an elevation similar to FIG. 94 showing the backplane connector assembly mated with the backplane adapter assembly;

FIG. 96 is an elevation similar to FIG. 95 showing the backplane connector assembly being extracted from a mated configuration;

FIG. 97 is an elevation similar to FIG. 96 showing the backplane connector assembly extracted;

FIG. 98 is a partially exploded perspective of the backplane adapter assembly of the backplane connection system of FIG. 90;

FIG. 99 is an elevation of the backplane adapter assembly of FIG. 98;

FIG. 100 is a perspective of the backplane adapter assembly of FIG. 98 showing fiber optic adapters thereof separated from a remainder of the backplane adapter assembly;

FIG. 101 is a perspective of the backplane adapter assembly of FIG. 98 showing behind the wall fiber optic connectors approaching the adapter assembly;

FIG. 102 is an exploded perspective showing a multi-connector chassis of the backplane connection system of FIG. 90;

FIG. 103 is an exploded perspective of the backplane connector assembly of the backplane connection system of FIG. 90;

FIG. 104 is another exploded perspective of the backplane adapter assembly of FIG. 98;

FIG. 105 is a perspective of the backplane adapter assembly of FIG. 98; and

FIG. 106 is an elevation of the backplane adapter assembly of FIG. 98.

Corresponding parts are given corresponding reference characters throughout the drawings.

### DETAILED DESCRIPTION

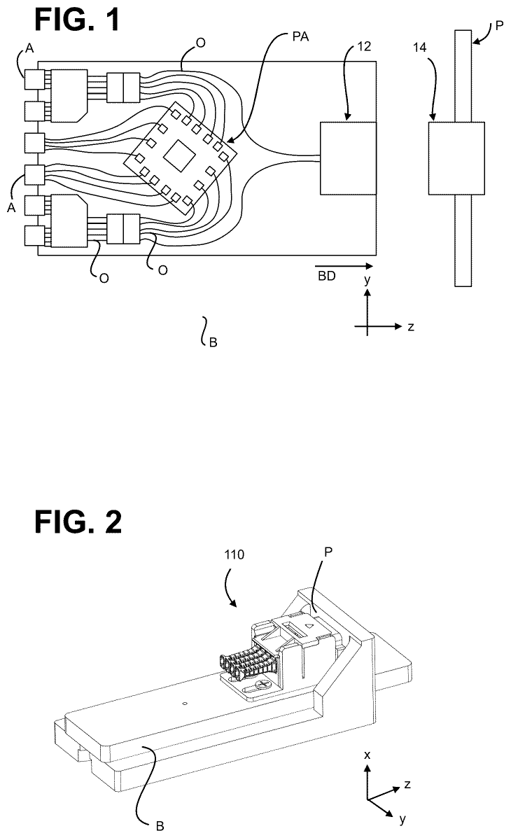

FIG. 1 provides a schematic overview of an example of a rack space in a modern high-density data processing system. A module M (e.g., daughter card, line card, compute module, GPU module, etc.) comprises various electronic and photonic components mounted on a module body B, which provides structural support. A central processing assembly PA incorporates one or more integrated circuits and serves as a primary hub for data handling for the module M. Optical fibers O are disposed on the module body B to facilitate high-speed data transmission.

As depicted in FIG. 1, optical fibers O connect to the central processing assembly PA and route optical signals to various interface points on the module M. Certain optical fibers O extend toward a front end of the module body B, terminating at one or more fiber optic connectors that are mated in the behind-the-wall ports of front panel fiber optic adapters A. The front panel adapters A are configured to provide detachable optical connections at the front of a networking rack, enabling high-level data communication between the module M and external devices or network infrastructure (not shown) when the module is installed. Other optical fibers O extend toward a rear end of the module body B.

This disclosure pertains primarily to a fiber optic backplane connection system, generally indicated at reference number 10, which is configured for connecting a module M (or other data processing element) to a backplane panel P. The fiber optic backplane connection system 10 comprises a backplane connector assembly 12 that is supported on the module body B and a backplane adapter assembly 14 supported on the panel P (e.g., a backplane PCB). The backplane connector assembly 12 terminates a set of the module's optical fibers O and is configured for connecting the module M with data processing system infrastructure by blind mating with the backplane adapter system 14. In typical operation, the module M is inserted along a z-axis into a network rack chassis (not shown). Features of the network rack chassis and module body B (e.g., drawer slides) can be used to guide insertion of the module M along the z-axis. During insertion, the backplane connector assembly 12 aligns with and blind mates to the complementary backplane adapter assembly 14. This blind mated optical connection facilitates data communication between the module M and other modules or subsystems interconnected via the backplane.

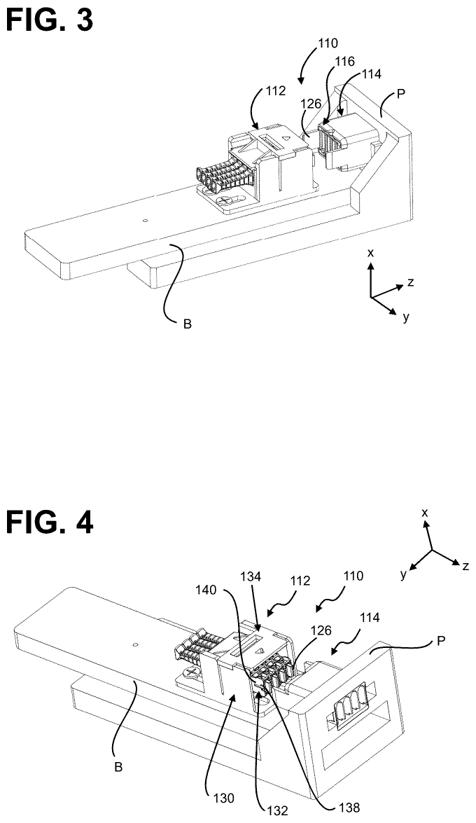

Referring now to FIGS. 2-5, an exemplary embodiment of a fiber optic backplane connection system that may be used in a fiber optic networking application like the one depicted in FIG. 1 is generally indicated at reference number 110. The fiber optic backplane connection system 110 comprises a backplane connector assembly 112 for mounting on a module body B (shown in a rudimentary form to focus the drawings on the fiber optic backplane connection assembly) and a backplane adapter assembly 114 for mounting on a panel P. The backplane connection system 110 has an x-axis (e.g., a vertical axis), a y-axis (e.g., a lateral axis), and a z-axis (e.g., a longitudinal axis or insertion axis). In use, the x-axis, y-axis, and z-axis are oriented so that the module body B extends in a plane parallel to the y-axis and z-axis and the panel P extends in a plane parallel to the x-axis and y-axis. As will be explained more fully below, the backplane connector assembly 112 is configured to blind mate with the adapter assembly 114 when the module body B is moved in a backward insertion direction BD relative to the panel P from a first position (FIG. 3) to a second position (FIG. 2).

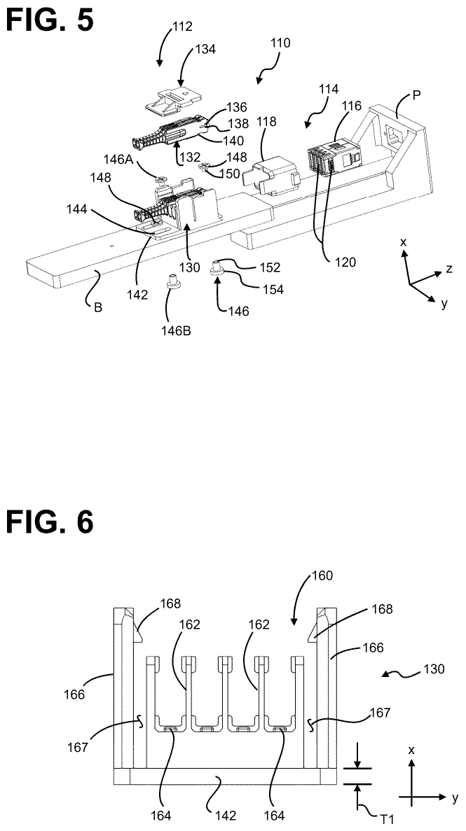

Referring to FIG. 5, the backplane adapter assembly 114 comprises a fiber optic adapter 116 configured to be supported on the panel P (e.g., via a panel clip). The backplane adapter assembly 114 further comprises an adapter collar 118 configured for surrounding the fiber optic adapter 116 on the front side of the panel P. The fiber optic adapter 116 comprises a plurality of connector ports 120 arranged in a row along the y-axis. In the illustrated embodiment, the fiber optic adapter 116 is a quad SN-MT adapter. The illustrated fiber optic adapter 116 has four ports 120 arranged in a row along the y-axis. Each port 120 is configured to mate with an SN-MT fiber optic connector 132, as will be explained in further detail below. In one or more embodiments, the adapter 116 is a shuttered adapter. The four ports 120 open through the front end of the adapter 116, and additional ports (not shown; e.g., behind-the-wall ports) open through the back end of the adapter for receiving four additional fiber optic connectors (e.g., behind-the-wall connectors) associated with the back plane equipment. When the backplane connector assembly 112 is blind mated with the backplane adapter assembly 114, optical connections are made between the fiber optic connectors 132 of the backplane connector assembly and the other fiber optic connectors mated with the ports on the back side of the adapter 116.

Although the illustrated embodiment, uses a quad SN-MT adapter 116, it will be understood that fiber optic backplane connection systems and backplane adapter assemblies in the scope of the disclosure can have other types of fiber optic connector ports, specifically, fiber optic connector ports for mating with any suitable type of push-pull fiber optic connector. Examples of other suitable adapter types that may be used without departing from the scope of this disclosure include SN, MPO, MU, SC, CS, MDC, and MMC.

In the illustrated embodiment, the backplane adapter assembly 114 comprises a single fiber optic adapter 120. In other embodiments according to the scope of the present disclosure, the backplane adapter assembly includes a plurality of adapters, e.g., a plurality of single-port or multi-port adapters collectively configured for mating with a plurality of push-pull fiber optic connectors.

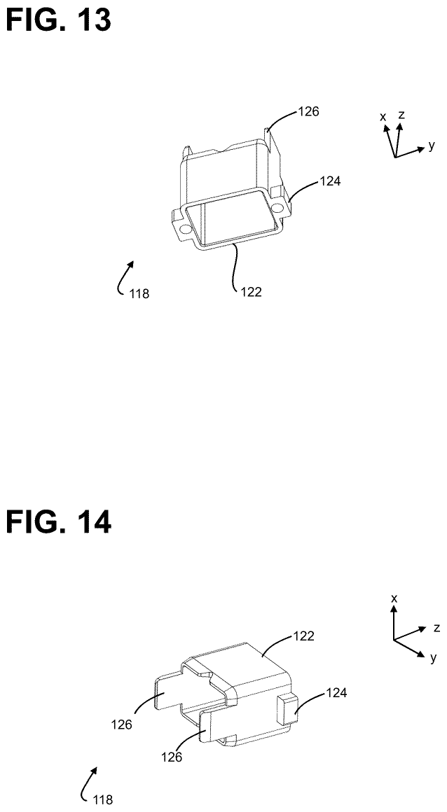

Referring to FIGS. 13 and 14 the adapter collar 118 is configured to be secured to the panel P and surround the fiber optic adapter 114. Thus, the illustrated adapter collar 118 comprises a rectangular shroud portion 122. A screw flange 124 (broadly, a mounting flange) is formed at a rear end portion (along the z-axis) of the shroud portion 122. The screw flange 124 is used to secure the adapter collar 118 to the panel P. Opposite the screw flange 124, the adapter collar 118 comprises at least one cantilevered guide finger 126 projecting forward from the shroud portion 122. In the illustrated embodiment, the adapter collar 118 comprises first and second guide fingers 126 cantilevered forward from opposite first and second side walls of the shroud portion 122 (which are spaced apart from one another along the y-axis). In the assembled backplane adapter assembly 114, the guide fingers 126 project forward beyond the front end of the fiber optic adapter 116 (see FIG. 3). As explained further below, the guide fingers 126 are configured to guide alignment of the fiber optic backplane connection system 110 during blind mating.

Referring to FIGS. 4 and 5, the backplane connector assembly 112 comprises a multi-connector chassis 130, a plurality of push-pull fiber optic connectors 132, and a cover 134. As will be explained in further detail below, the multi-connector chassis 130 and the cover 134 are configured to hold the push-pull fiber optic connectors 132 on the module body B so that the push-pull fiber optic connectors plug into the fiber optic connector ports 120 of the backplane adapter assembly 114 when the backplane connector assembly 112 is blind mated with the backplane adapter assembly.

In general, each push-pull fiber optic connector 132 comprises one or more fiber optic ferrules 136, a ferrule holder 138, and a pullback extraction mechanism 140 configured to be pulled backward in relation to the ferrule holder. Each fiber optic connector 132 is broadly configured to terminate a jacketed or non-jacketed fiber optic cable (not shown), and each fiber optic ferrule 136 is broadly configured to terminate at least one optical fiber (e.g., an optical fiber O of the Module M depicted in FIG. 1). Each push-pull fiber optic connector 132 is configured to latch with the fiber optic adapter 116 when the push-pull fiber optic connector is mated with the respective connector port 120. The pullback extraction mechanism 140 is generally configured to unlatch the push-pull fiber optic connector 132 from the connector port 120 when pulled back in relation to the ferrule holder 138.

In the illustrated embodiment, the push-pull fiber optic connectors 132 are SN-MT connectors. In other embodiments, other types of push-pull fiber optic connectors 132 can be used (e.g., the push-pull connectors are SN, MPO, SN-MT, MU, SC, CS, MDC, or MMC connectors). In an SN-MT connector as shown, the pullback extraction mechanism 140 includes an outer housing (and linked push-pull boot) configured to be displaced rearward in relation to the ferrule holder 138, whereby ramp features on the outer housing bear against opposing latch arms (internal components of the fiber optic adapter 116 that are concealed in the drawings) to spread the latch arms and unlatch them from latch recesses on opposite sides of the ferrule holder. The SN-MT connector is available from the assignee of the present disclosure, and the functioning of its latching and pullback extraction mechanism 140 can be easily understood from the foregoing by those skilled in the art after inspecting an SN-MT connector and adapter. The way SN-MT connectors latch and unlatch from an adapter is described in further detail in U.S. Pat. Nos. 10,852,490 and 11,187,857.

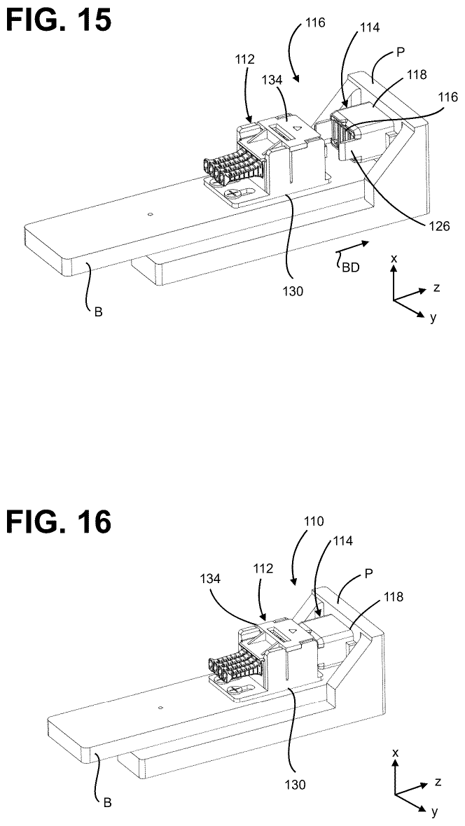

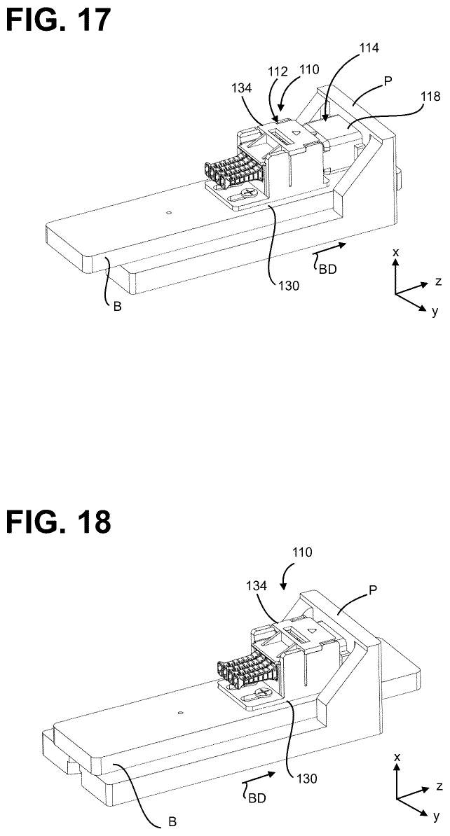

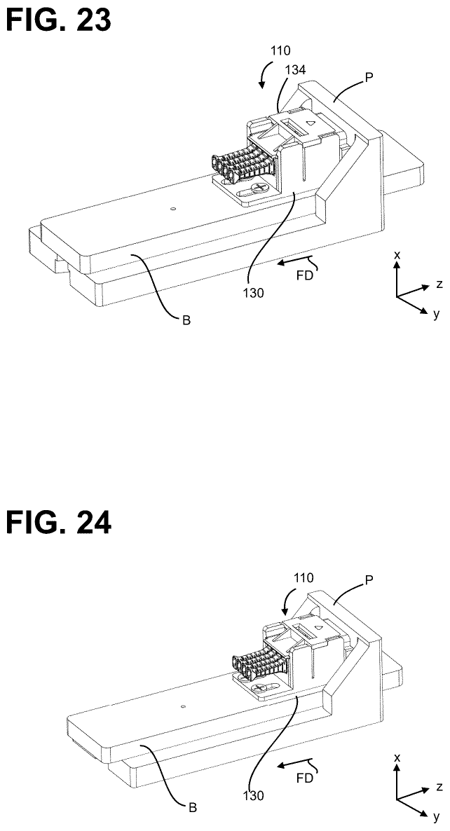

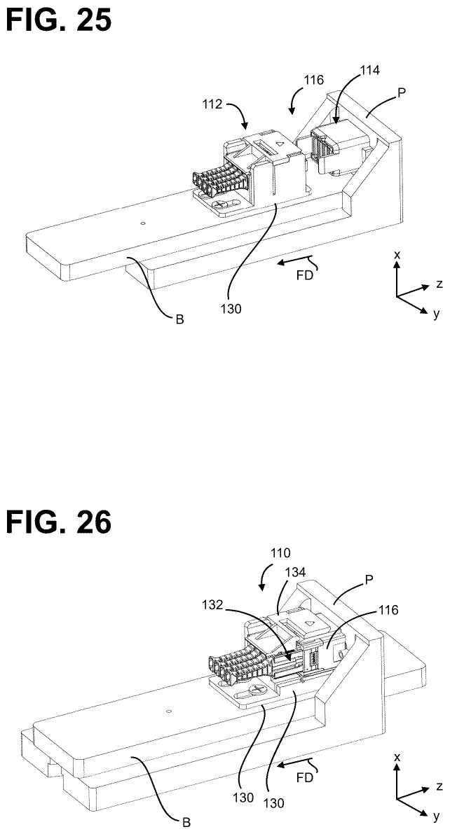

The multi-connector chassis 130 is mounted on the module body B such that the multi-connector chassis is configured to move substantially with the module body in relation to the panel P and the backplane adapter assembly 11. As shown in FIGS. 15-18, the module body B is movable in relation to panel P and the backplane adapter assembly 114 in an insertion direction BD along the z-axis of the backplane connection system 110 between a first position (FIG. 15) and a second position (FIG. 18). As shown in FIGS. 23-25, the module body B is also movable in relation to the panel P and the backplane adapter assembly 114 in a forward extraction direction FD along the z-axis of the backplane connection system 110 between the second position (FIG. 23) and the first position (FIG. 25). The multi-connector chassis 130 generally moves with the module body B as the module body moves along the z-axis between the first position and second position. But as will be explained in further detail below, the multi-connector chassis 130 is configured for a limited range of floating movement in relation to the module body B.

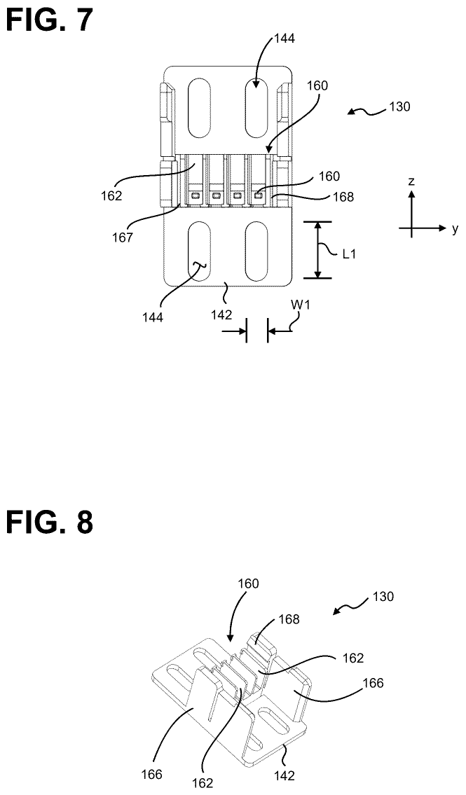

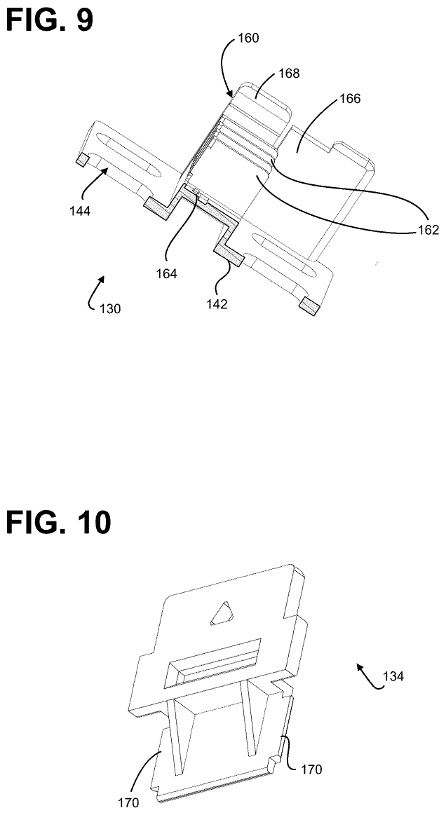

Referring to FIGS. 6-9, the illustrated multi-connector chassis 130 comprises a base 142 configured to be fastened to the module body B so that the multi-connector chassis moves substantially with the module body in relation to the panel P and a backplane adapter assembly 114 as described above. The base 142 is configured to be supported on the module body B. The base 142 has a top side, a bottom side, and a thickness T1 (FIG. 6) extending along the x-axis from the bottom side to the top side. The base 142 defines one or more slots 144 extending through the thickness of the base. Each slot 144 has a first end, a second end, and a length L1 (FIG. 7) extending along the z-axis from the first end to the second end. Each slot 144 also has a first side, a second side, and a width W1 (FIG. 7) extending along the y-axis from the first side to the second side.

Referring to FIG. 5, the backplane connector assembly 112 further comprises one or more fasteners 146 for securing the multi-connector chassis 130 to the module body B such that the multi-connector chassis is configured for movement relative to the module body in a limited range of floating motion. For example, the backplane connector assembly 112 can comprise one fastener 146 loosely received in each slot 144 for securing the multi-connector chassis 130 to the module body B. In the illustrated embodiment, each fastener 146 comprises a binding post comprising an upper part 146A and a lower part 146B. The upper part 146A has a head 148 and an externally threaded shaft 150 that threads into an internally threaded shaft 152 of the lower part 146B. A lower head 154 is formed on the lower fastener part 146B on the end of the internally threaded shaft 152. When installed, the head 148 of the upper part 146A is located above an upward facing surface of the base 142, and the internally threaded shaft 152 is received in the slot 144 to form a bearing portion of the fastener 146. In one or more embodiments, the outer cross-sectional dimensions of the bearing portion of the fastener 146 along the y-axis and/or z-axis are less than the slot width W1 and/or slot length L1 respectively so that the slot accommodates a limited range of motion (floating) of the multi-connector chassis 130 along the y-axis and/or z-axis. Additionally, the length of each fastener 146 along the z-axis can be sufficiently great so that the upper head 148 will be spaced apart from the module body B along the x-axis by a height that is greater than the thickness T1 of the base 130, which provides clearance for a limited range of motion (floating) of the multi-connector chassis 130 along the x-axis with respect to the module body.

Accordingly, in one or more embodiments, each fastener 146 is received in the slot 144 such that the multi-connector chassis 130 is configured for movement relative to the module base B in a limited range of z-axis floating motion extending from a first terminal z-axis position in which the base 142 abuts the fastener at the first end of the slot to a second terminal z-axis position in which the base abuts the fastener at the second end of the slot. In certain embodiments, the fastener 146 is received in the slot 144 such that the multi-connector chassis 130 is configured for movement relative to the module base B in a limited range of y-axis floating motion extending from a first terminal y-axis position in which the base 142 abuts the fastener at the first side of the slot to a second terminal y-axis position in which the base abuts the fastener at the second side of the slot. In some embodiments, the multi-connector chassis 130 is configured for movement relative to the module base B in a limited range of x-axis floating motion extending from a first terminal x-axis position in which the top side of the base 142 is spaced apart from the upper head 148 along the x-axis to a second terminal x-axis position in which the top side of the base abuts the upper head.

Referring again to FIGS. 6-9, the multi-connector chassis further comprises a cradle portion 160 on the base 142. The cradle portion 160 defines a plurality of connector retainers 162 arranged in a line along a y-axis. Each connector retainer 162 is configured to receive and retain one of the push-pull fiber optic connectors 132. In addition, each connector retainer 162 is configured to operatively engage the pullback extraction mechanism 140 of the respective push-pull fiber optic connector 132 so that the multi-connector chassis 130 is configured to simultaneously displace the pullback extraction mechanisms 140 rearward in relation to the ferrule holders 138 to unlatch the mated push-pull fiber optic connectors 132 from the fiber optic adapter 116 when the module body B is pulled in the rear direction RD from the second position to the first position. In the illustrated embodiment, each connector retainer 162 comprises a protrusion 164 configured to operatively engage the pullback extraction mechanism 140 by being seated in a recess of the SN-MT outer housing when the push-pull fiber optic connector 132 is retained in the retainer.

The cradle portion 160 also comprises first and second end walls 166 spaced apart along the y-axis on opposite sides of the grouping of connector retainers 162. In the illustrated embodiment, the end walls 166 are spaced apart outboard of the connector retainers 162 so that the cradle 160 defines guide slots 167 between the end walls and the connector retainers. The guide slots 167 are generally configured for accepting the cantilevered guide fingers 126 of the adapter collar 118 when the backplane connector assembly 112 is blind mated with the backplane adapter assembly 114. Each end wall 166 defines a latch feature 168 that is configured for securing the cover 134 on the multi-connector chassis 130.

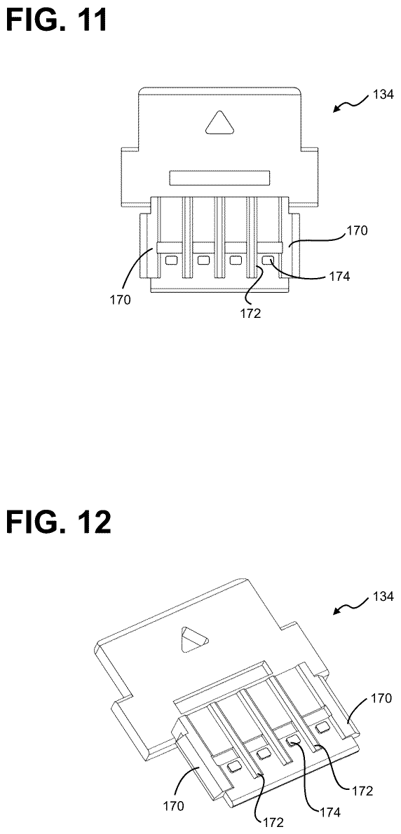

Referring to FIGS. 10-12, the cover 134 is configured to be supported on the first and second end walls 166 and fastened to the multi-connector chassis 130 to secure the plurality of push-pull fiber optic connectors 132 in the cradle portion 160. In general, the cover 134 comprises a body that spans the y-axis distance between the first and second end walls 166 and includes latch features 170 on opposite sides for latching with the latch features 168 of the cradle portion 150. When the cover 134 is secured to the cradle portion 160, the multi-connector chassis 130 and the cover 134 define a receptacle in which the plurality of push-pull fiber optic connectors 132 are received (see, e.g., FIGS. 3 and 4). The receptacle is also configured to receive (in mating fashion) the adapter collar 118 when the backplane connector assembly 112 is blind mated with the backplane adapter assembly 114. The cover 134 and the multi-connector chassis 130 enclose the guide slots 167 on four sides. As will be explained in further detail below, during blind mating, the backplane connector assembly 112 is configured to receive the adapter collar 118. In addition, the guide slots 167 are configured to receive the cantilevered guide fingers 126 of the collar to aid in guiding the backplane connector assembly 112 to mate with the backplane adapter assembly 114.

In the illustrated embodiment, the cover 134 comprises additional connector retainer features 172 that cooperate with the connector retainers 162 of the cradle portion 160 to operatively retain the push-pull fiber optic connectors 132 in the receptacle. The connector retainer features 172 of the cover include protrusions 174 configured to operatively engage the pullback extraction mechanisms 140 by being seated in recesses formed in the outer SN-MT housing when the push-pull fiber optic connector 132 is retained in the receptacle.

Accordingly, when the push-pull fiber optic connectors are installed in the multi-connector chassis 130 and the cover 134 is secured in place, each pullback extraction mechanism 140 is retained in a respective one of the connector retainers 162 and a respective one of the connector retention features 172 such that the pullback extraction mechanisms are movable with the multi-connector chassis in relation to the ferrule holders 138. Further, when the push-pull fiber optic connectors are installed in the multi-connector chassis 130 and the cover 134 is secured in place, the multi-connector chassis 130 and/or cover 134 defines the guide slots 167 so that the guide slots are configured to receive the cantilevered guide fingers 126 when the module body B moves from the first position and the second position.

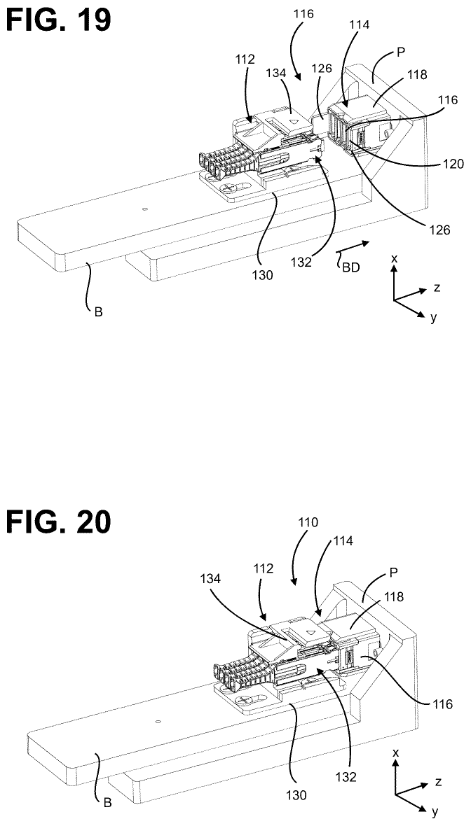

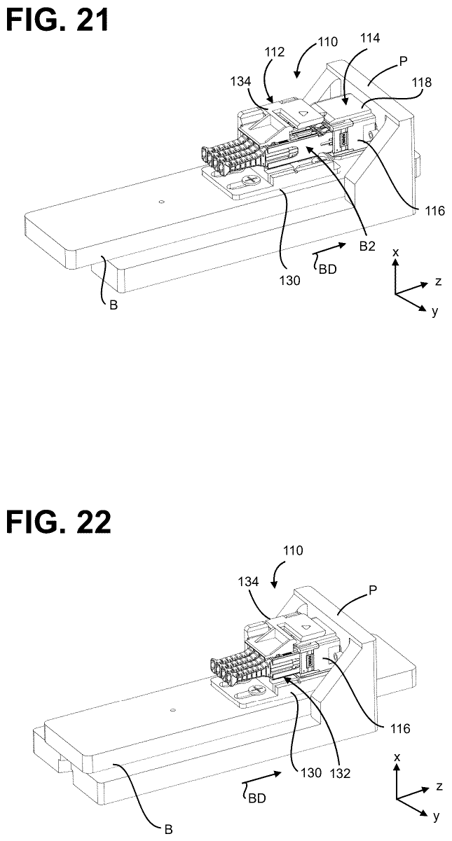

FIGS. 15-18 depict an example sequence of blind mating the backplane connector assembly 112 with the backplane adapter assembly 114. FIGS. 19-22 depict the same sequence but show the multi-connector chassis 130 and the adapter collar 118 in a fragmentary view to illustrate how the push-pull fiber optic connectors 132 enter the fiber optic adapter 116. As shown in FIG. 15 and FIG. 19, the blind mating sequence begins with the push-pull fiber optic connectors 132 installed on the multi-connector chassis 130, the multi-connector chassis mounted (to float) on the module body B, and the module body in a first position along the z-axis. From this position, a user moves the module body in the backward insertion direction BD along the z-axis to the second position (FIGS. 18 and 22). Initially, the cantilevered guide fingers 126 enter the receptacle defined by the multi-connector chassis 130 and the cover 134. This coarsely pre-aligns the backplane connector assembly 112 with the backplane adapter assembly 114. The guide fingers 126 advance further and are received in the guide slots 167, which refines the pre-alignment of the backplane connector assembly 112 with the backplane adapter assembly 114. Because of the floating range of motion of the multi-connector chassis 130 in relation to the module body B, any minor misalignment between the guide fingers 126 and the guide slots 167 is automatically corrected as the guide fingers 126 advance into the guide slots. This pre-aligns the push-pull fiber optic connectors 132 with the connector ports 120 of the fiber optic adapter 116 with a sufficient degree of accuracy that further advancement of the module body B in the insertion direction BD plugs the push-pull fiber optic connectors into the connector ports so that the push-pull fiber optic connectors are all simultaneously blind mated with the connector ports by the module body moving in insertion direction from the first position and the second position. Again, because of the floating range of motion of the multi-connector chassis 130 in relation to the module body B, any minor misalignment between the push-pull fiber optic connectors 132 and the fiber optic adapter 116 is corrected automatically as the push-pull fiber optic connectors advance into the connector ports 20. The z-axis floating range of motion can clearly be seen by comparing FIGS. 20 and 21.

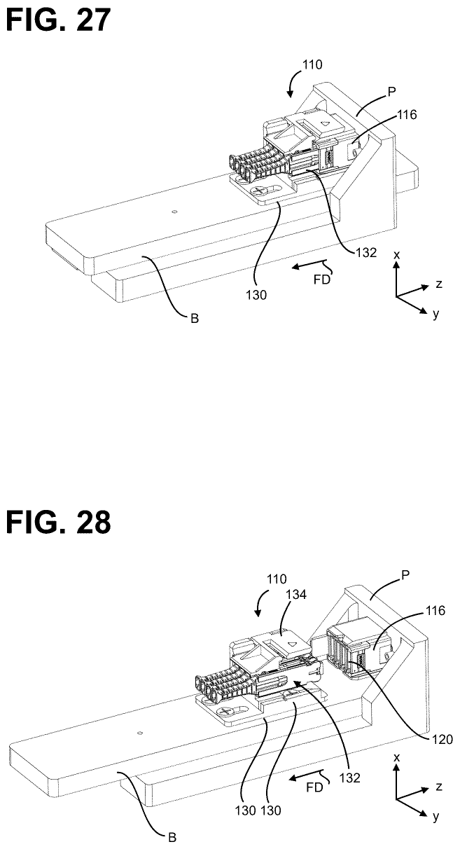

FIGS. 23-25 depict an example sequence of extracting the backplane connector assembly 112 from the backplane adapter assembly 114, and FIGS. 26-28 depict the same sequence but show the multi-connector chassis 130 and the adapter collar 118 in a fragmentary view to illustrate how the push-pull fiber optic connectors 132 are extracted from the fiber optic adapter 116. As explained above, the multi-connector chassis 130 and/or the cover 134 is/are configured to engage the pullback extraction mechanism 140 of each of the push-pull fiber optic connectors 132 such that the push-pull fiber optic connectors are all pulled backward in relation to the respective ferrule holders 138 simultaneously when the module body B is moved in the extraction direction FD. This unlatches all of the push-pull fiber optic connectors 132 from the fiber optic adapter 116 and extracts all of the push-pull fiber optic connectors from the connector ports 120 when the module body is moved in an extraction direction from the second position to the first position. Hence, the push-pull fiber optic connectors 132 can all be simultaneously unlatched from the fiber optic adapter 116 by using the module body B to pull the multi-connector chassis 130 backward.

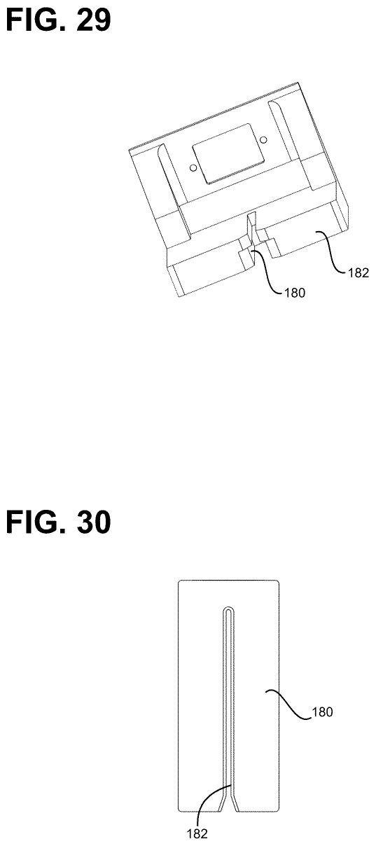

Referring to FIGS. 29-30, in one or more embodiments, the backplane connection system 110 comprises a guide plate 180 supported on the panel P and extending outward from the panel along the z-axis. The guide plate 180 is configured to support the module body B for sliding movement between the first position and the second position. Here, the guide plate 180 defines a (T-shaped) groove 182 extending along the z-axis and the slider comprises a protruding feature (e.g., a stud with an enlarged head, a t-shaped tongue; not shown) slidingly and interlockingly received in the groove such that feature is constrained to slide along the groove in relation to the guide plate 180 along the z-axis. Various mechanisms and structures can be used for guiding the module body B along the z-axis in a way that facilitates blind mating of the backplane connector assembly 112 with the backplane adapter assembly 114.

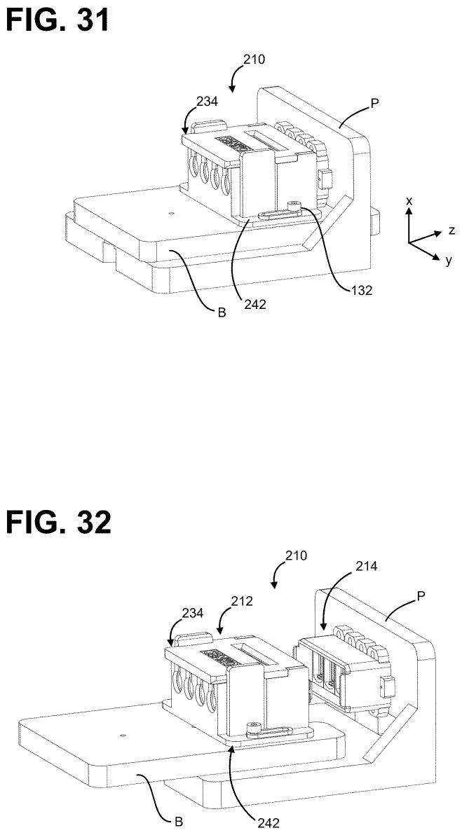

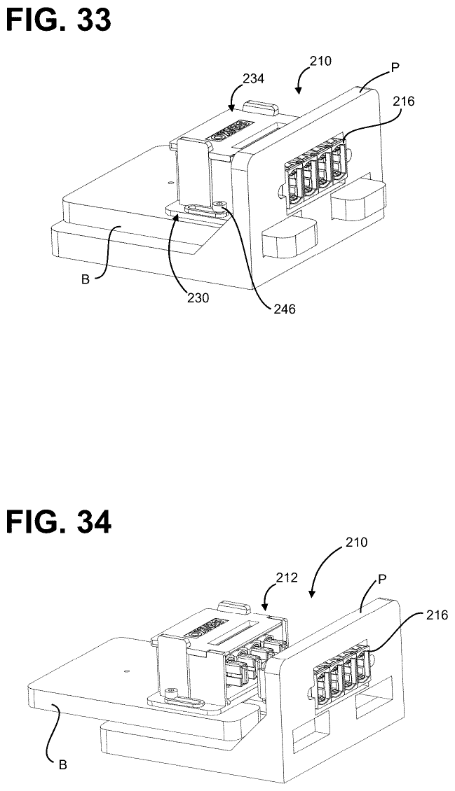

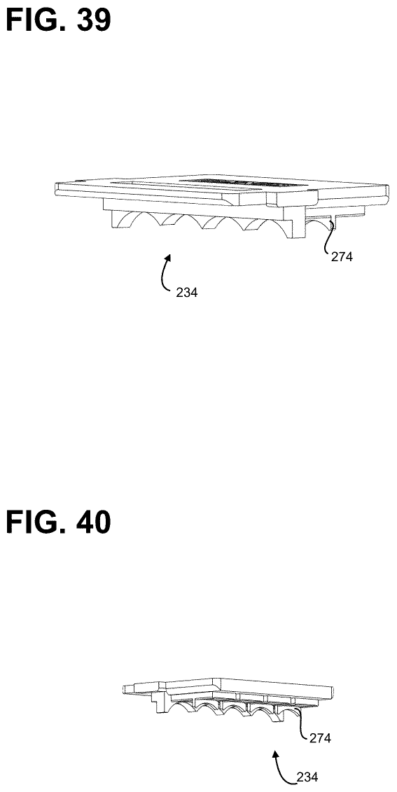

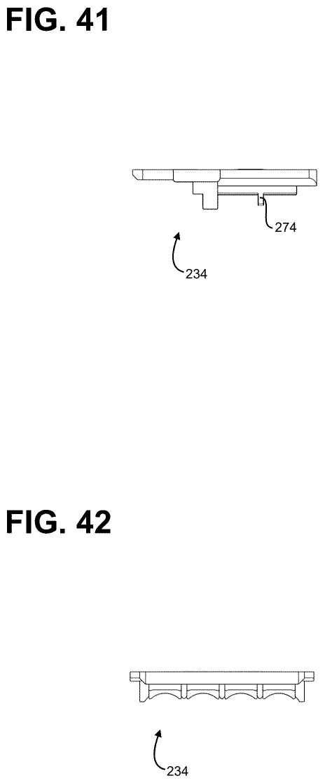

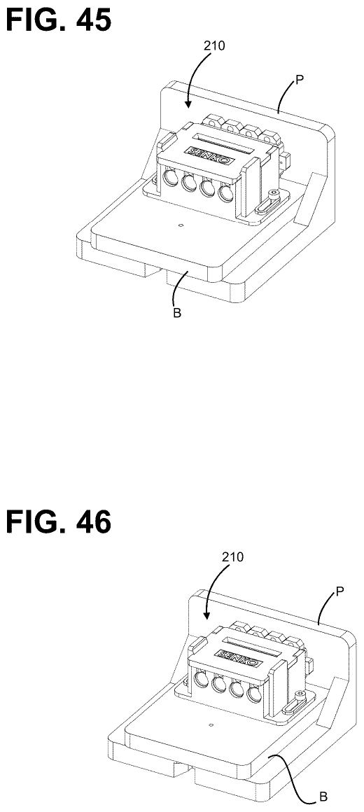

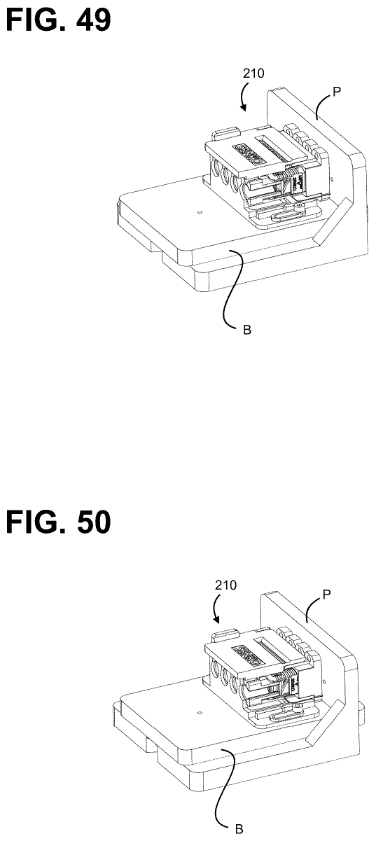

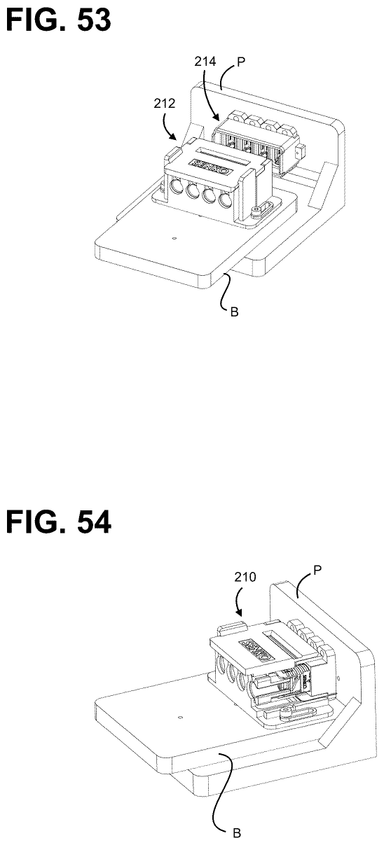

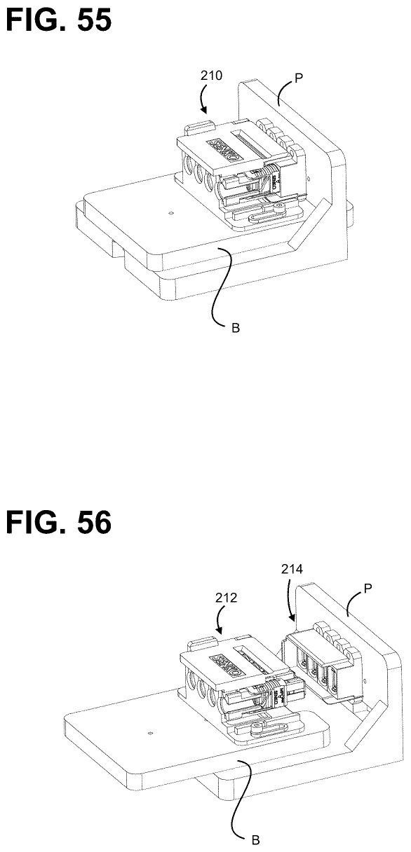

Referring to FIGS. 31-56, another embodiment of a backplane connection system in accordance with the present disclosure is generally indicated at reference number 210. The backplane connection system 210 is similar to the backplane connection system 110, and corresponding parts are given the same reference numbers, plus 100. The backplane connection system 210 primarily differs from the backplane connection system 110 in that the push-pull fiber optic connectors 232 are MPO connectors (specifically, modified MPO EZ Way connectors, the conventional versions of which are available from the assignee of the present disclosure) and the fiber optic adapter 216 is a set of four simplex MPO adapters arranged in a row along the y-axis, with each simplex MPO adapter oriented so that the fiber alignment axis extends vertically parallel to the x-axis. As with the previous backplane connection system 110, the backplane connection system 210 comprises a backplane connector assembly 212 configured to be mounted on a module body B and a backplane adapter assembly 214 configured to be mounted on a panel P. The backplane adapter assembly 214 comprises the MPO adapters 216 and an adapter collar 218 that functions similarly to the adapter collar 118 described above.

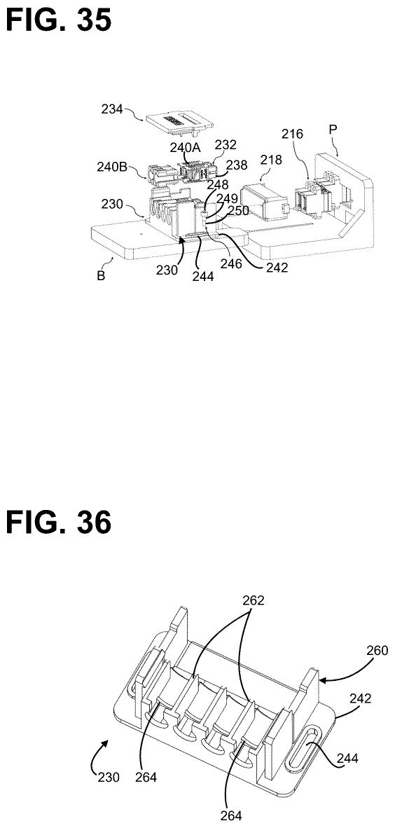

The backplane connector assembly 212 comprises a multi-connector chassis 230 mounted on a module body B such that the multi-connector chassis can float with respect to the module body in a limited range of z-axis motion and/or a limited range of y-axis motion and/or a limited range of x-axis motion. As above, the multi-connector chassis 232 comprises a base 242 with oversized mounting slots 244 configured to accept fasteners 246 for fastening to the module body B. As shown in FIG. 35, in the illustrated embodiment, the fasteners 246 are single-piece threaded fasteners with a smooth bearing portion 249 between an upper head 248 and an externally threaded shaft 250. In use, the threaded shaft 250 is secured in the module body B, the bearing portion 249 is received in the oversized slot 244, and the head 248 is positioned above the base 242.

A cover 234 connects to the top of the multi-connector chassis 230 to help retain the MPO connectors 232 in the multi-connector chassis 232. The multi-connector chassis 232 comprises a cradle portion 260 (FIG. 36) with four individual connector retainers 262, each having a protrusion 264 for connecting the multi-connector chassis 230 to the pullback extraction mechanism 240 of the MPO connector 232. The cover 234 similarly comprises protrusions 274 for connecting the multi-connector chassis 230 to the pullback extraction mechanism 240.

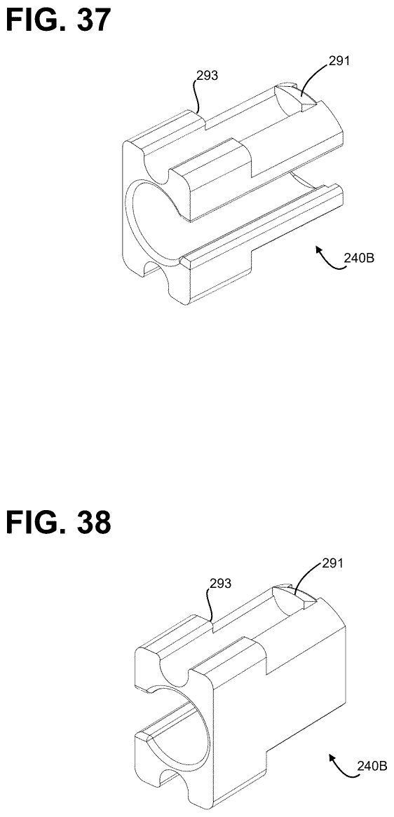

The MPO connectors 232 comprise MT ferrules 236, MPO ferrule holders 238, and a pullback extraction mechanism 240 that includes an MPO outer housing 240A and a back body 240B. The back body 240B includes latches 291 configured for operatively connecting the back body to the MPO outer housing in same the manner that the push-pull boot attaches in an MPO EZ Way connector (additional information about the MPO EZ Way connector is available in US Patent Application Publication No. 2024/0142724). The back body 240B of the pullback extraction mechanism 240 is shown in greater detail in FIGS. 37-38. As shown, the back body 240B comprises a flange 293. When the MPO connectors 232 are received in the connector retainers 262 and the cover 234 is secured to the multi-connector chassis 230, the protrusions 264, 274 engage the flange 293 so that pulling the multi-connector chassis 230 in the extraction direction FD pulls the pullback extraction mechanism 240 rearward in relation to the ferrule holders 238.

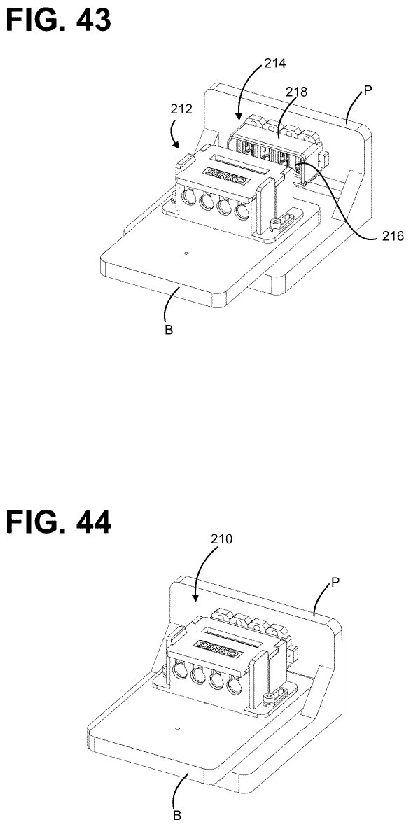

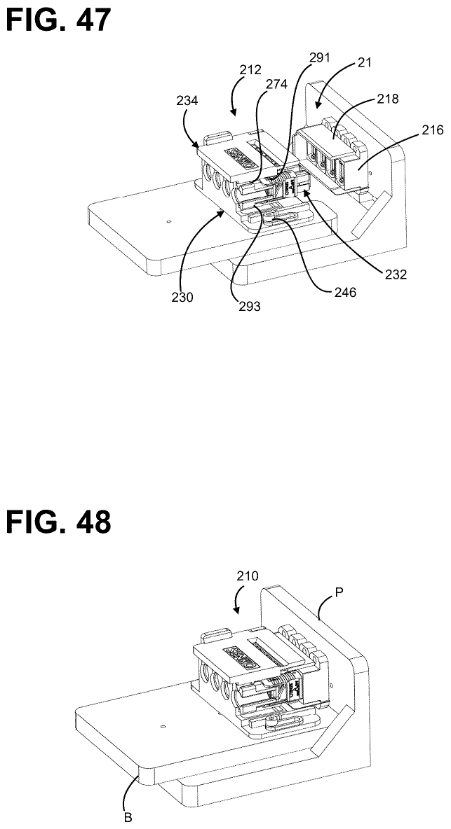

FIGS. 43-46 depict an example sequence of blind mating the backplane connector assembly 212 with the backplane adapter assembly 214. FIGS. 47-50 depict the same sequence but show the multi-connector chassis 230 and the adapter collar 218 in a fragmentary view to illustrate how the MPO connectors 232 enter the fiber optic adapters 216. As shown, when a user advances the module body B from a first position (FIGS. 43 and 47) to a second position (FIGS. 46 and 50), the adapter collar 218 is received in the receptacle defined by the multi-connector chassis 230 and the cover 324 and then the MPO connectors 232 are simultaneously plugged into the MPO adapters 216, which blind mates the backplane connector assembly 212 with the backplane adapter assembly 214. Because of the floating range of motion of the multi-connector chassis 230 in relation to the module body B, minor misalignments during blind mating are corrected automatically as the blind mate connector assembly 212 advances to mated relation with the backplane adapter assembly 214.

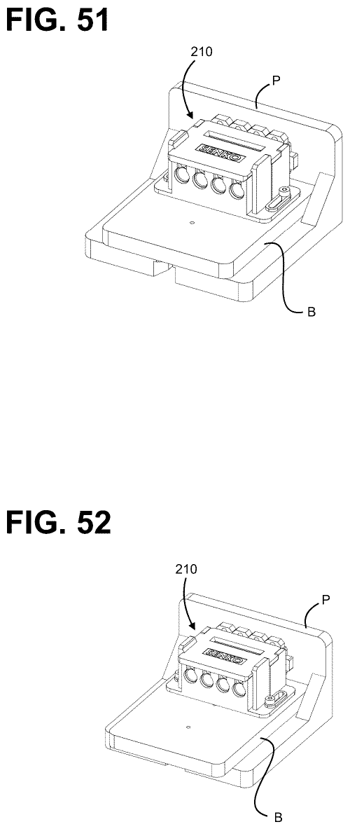

FIGS. 51-53 depict an example sequence of extracting the backplane connector assembly 212 from the backplane adapter assembly 214, and FIGS. 54-56 depict the same sequence but show the multi-connector chassis 230 and the adapter collar 218 in a fragmentary view to illustrate how the push-pull fiber optic connectors 232 are extracted from the fiber optic adapters 216. As explained above, the multi-connector chassis 230 and the cover 234 are configured to engage the flange 293 of the back body 240B of the pullback extraction mechanism 240 of each of the MPO connectors 232 such that the push-pull fiber optic connectors are all pulled backward in relation to the respective ferrule holders 238 simultaneously when the module body B is moved in the extraction direction FD. This unlatches all of the push-pull fiber optic connectors 232 from the fiber optic adapters 216 and extracts all of the push-pull fiber optic connectors.

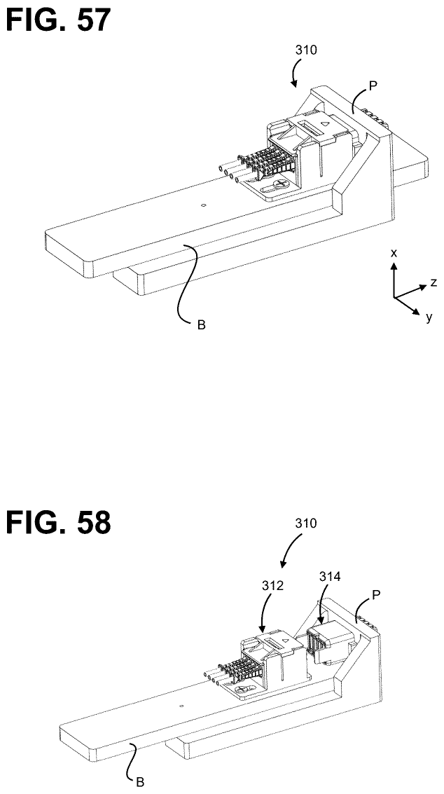

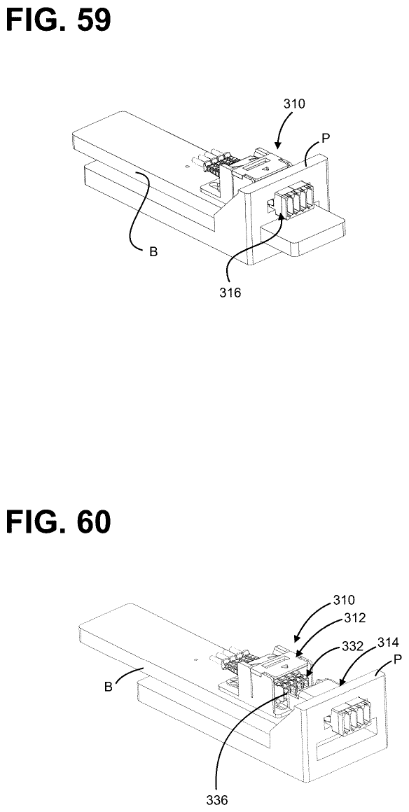

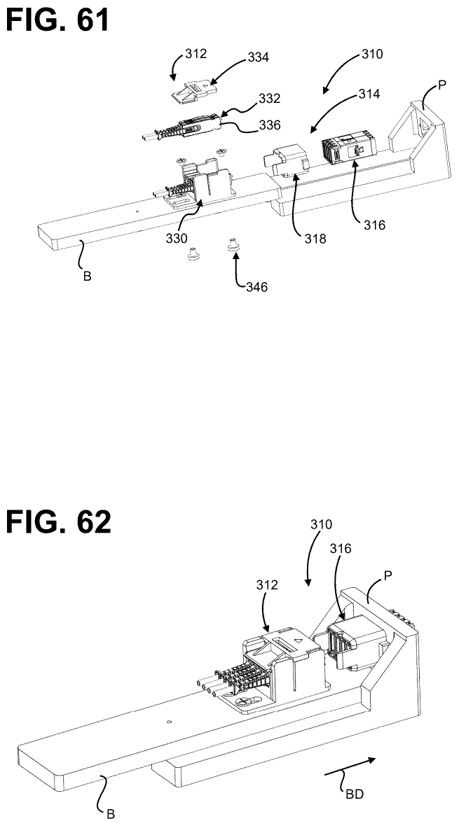

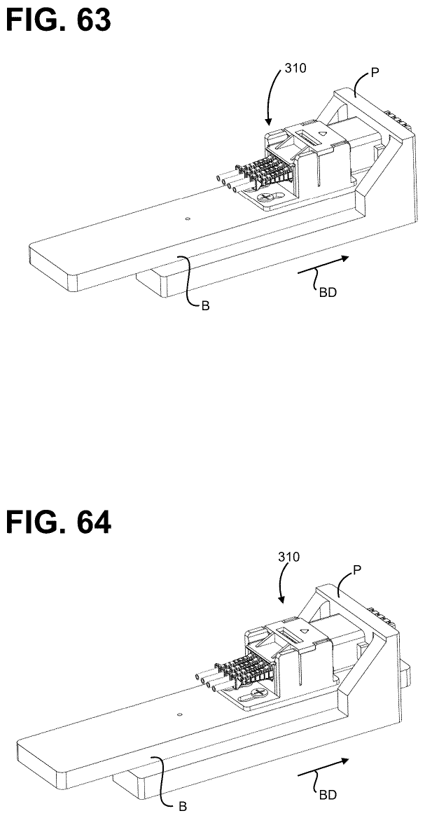

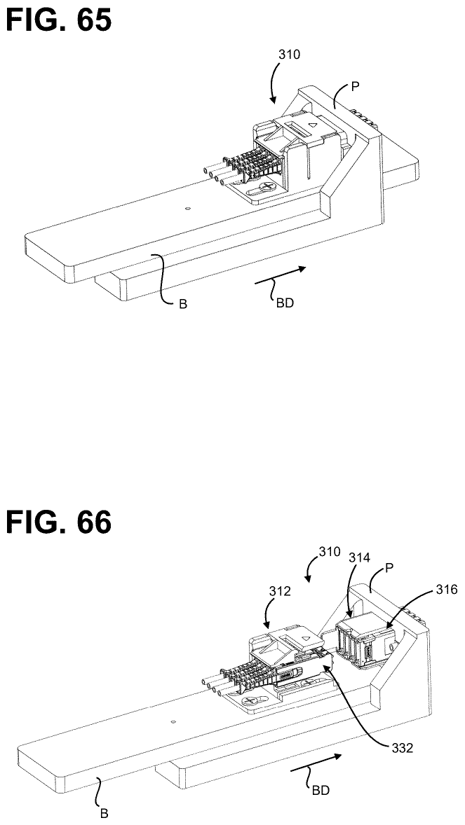

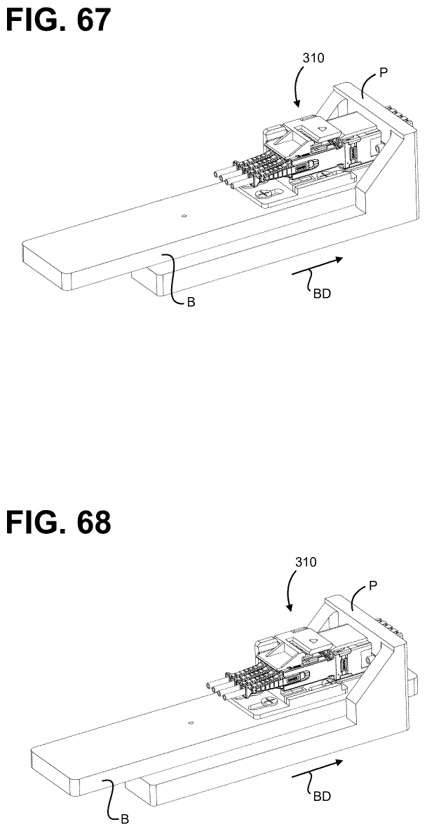

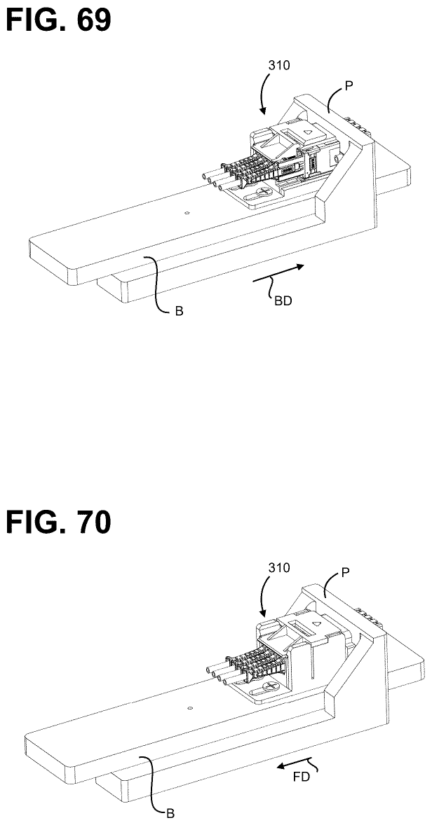

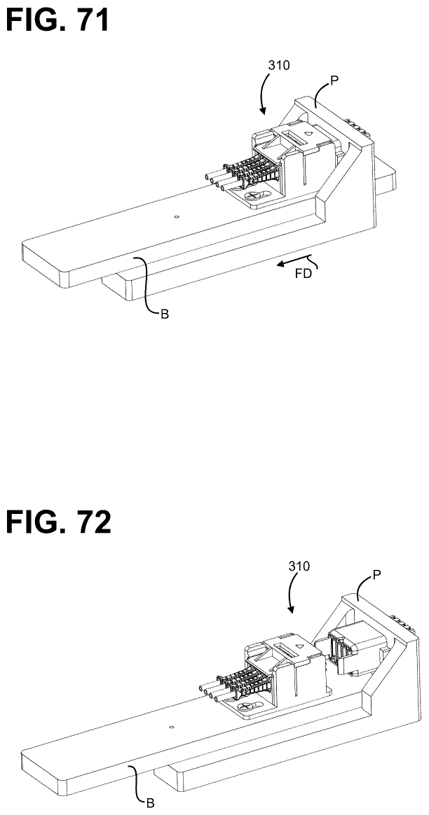

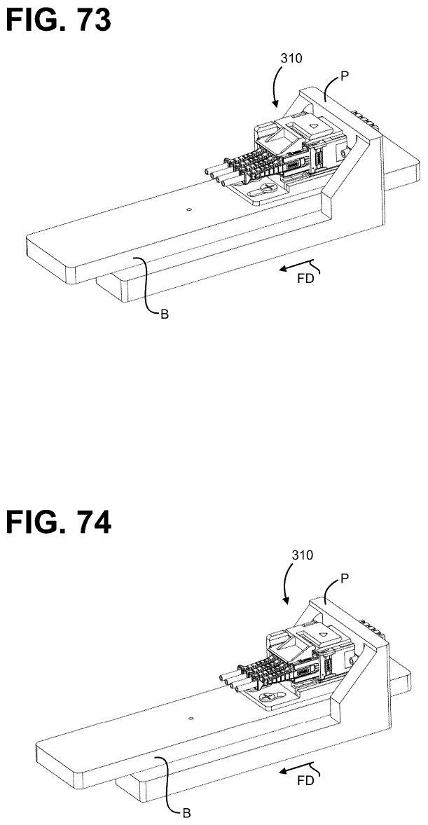

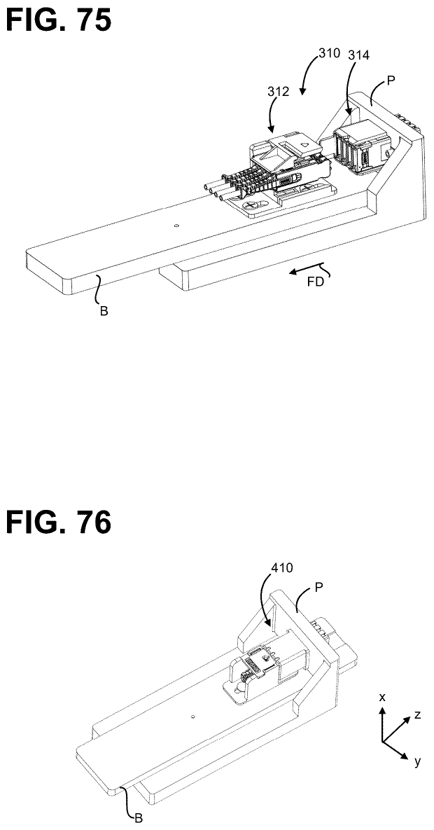

Referring to FIGS. 57-75, another embodiment of a backplane connection system in accordance with the present disclosure is generally indicated at reference number 310. The backplane connection system 310 is similar to the backplane connection system 110, and corresponding parts are given the same reference numbers, plus 200. As before, the backplane connection system 310 comprises a backplane connector assembly 312 configured to be mounted on a module body B and a backplane adapter assembly 314 configured to be mounted on a panel P. The backplane connection system 310 primarily differs from the backplane connection system 110 in that the push-pull fiber optic connectors 332 are SN duplex connectors with two single-fiber LC ferrules 336 instead of the single multifiber ferrule 136 and the fiber optic adapter 316 is a quad SN duplex adapter. The multi-connector chassis 330, cover 334, adapter collar 318, and floating fasteners 346 are essentially the same as the corresponding components in the backplane connection system 110.

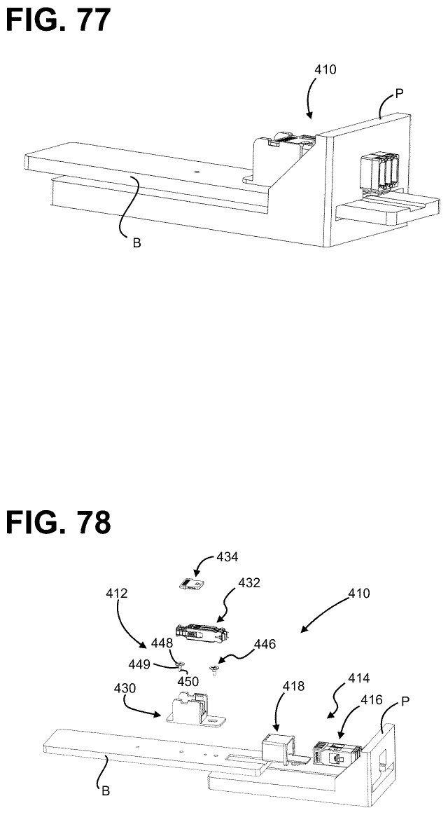

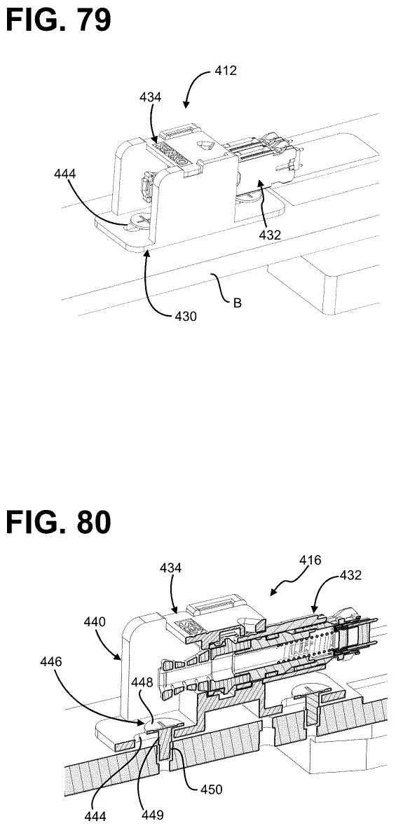

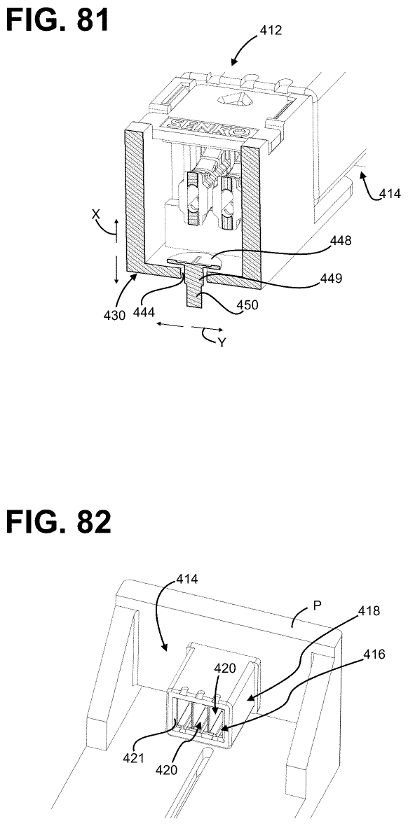

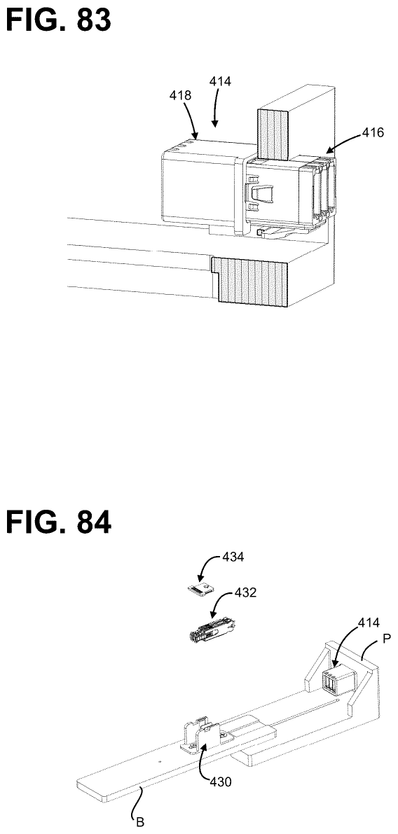

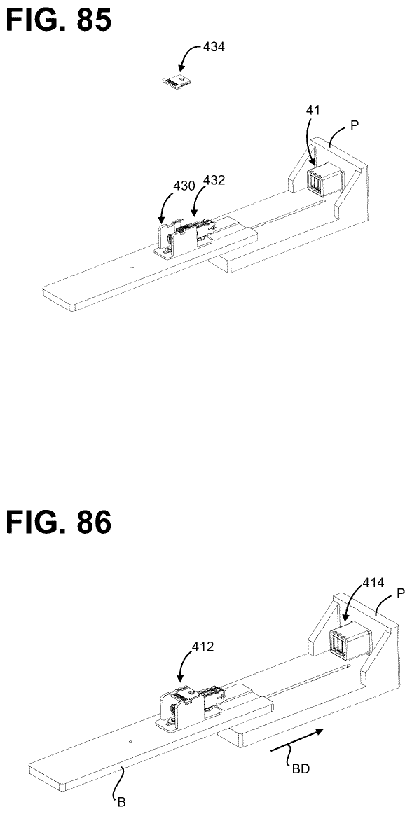

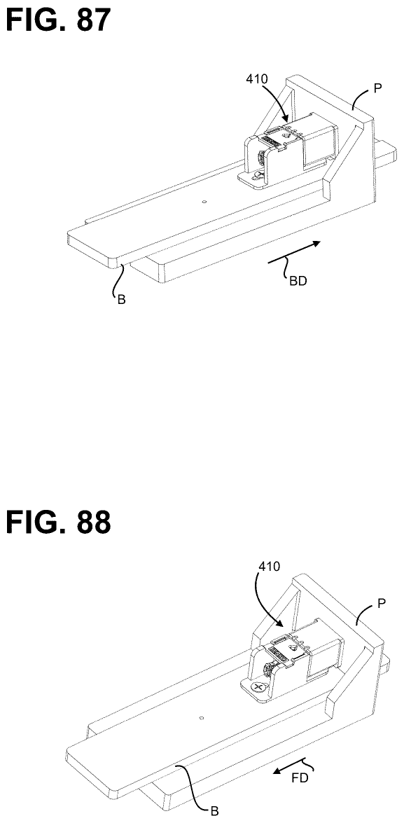

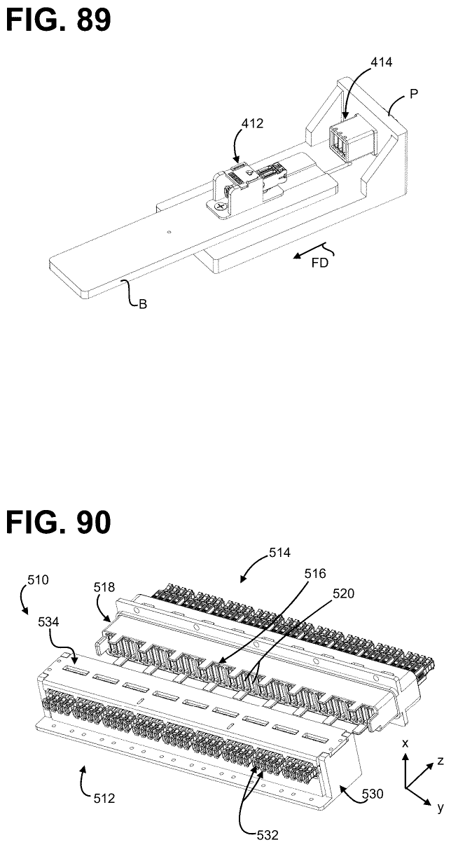

Referring to FIGS. 76-89, another embodiment of a backplane connection system in accordance with the present disclosure is generally indicated at reference number 410. The backplane connection system 410 is similar to the backplane connection system 110, and corresponding parts are given the same reference numbers, plus 300. As before, the backplane connection system 410 comprises a backplane connector assembly 412 configured to be mounted on a module body B and a backplane adapter assembly 414 configured to be mounted on a panel P. The backplane connection system 410 primarily differs from the backplane connection system 110 in that fewer push-pull fiber optic connectors 432 are used and a three-port fiber optic adapter 416 is used in place of the quad SN-MT adapter. The multi-connector chassis 430, cover 434, and adapter collar 418 are essentially the same as the corresponding components in the backplane connection system 110, different primarily in overall y-axis dimensions. As shown in FIG. 78-81, the two piece fasteners 146 are replaced with single-piece threaded fasteners 446. Each fastener 446 comprises a smooth bearing portion 449 between an upper head 448 and an externally threaded shaft 450. In use, the threaded shaft 450 is secured in the module body B, the bearing portion 449 is received in the oversized slot 444, and the head 448 is positioned above the base 442. As explained above, the fasteners 446 allow the multi-connector chassis 430, push-pull fiber optic connectors 432, and cover 434 to float with respect to the module body B in a limited range of motion. In the illustrated embodiment, the adapter collar 418 is devoid of cantilevered guide fingers and does not mate inside the receptacle defined by the multi-connector chassis 430 and the cover 434. Instead, to facilitate alignment of the push-pull fiber optic connectors 432 into the connector ports 420, a guide chamfer 421 is incorporated into the leading end of the adapter collar 418 as shown in FIG. 82. The guide chamfer 421 helps center the push-pull fiber optic connectors 432 in the connector ports 420 when the backplane connector assembly 412 is blind mated with the backplane adapter assembly 414.

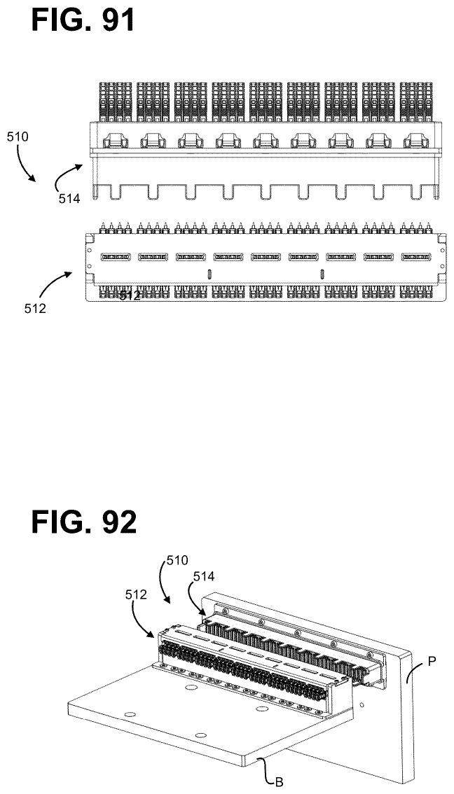

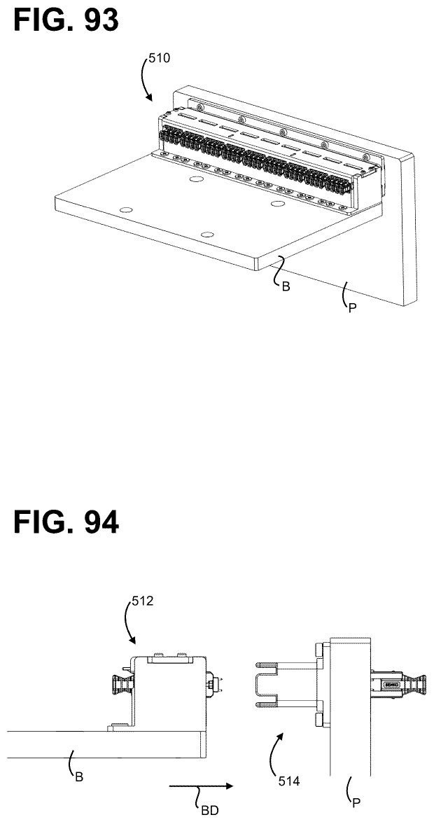

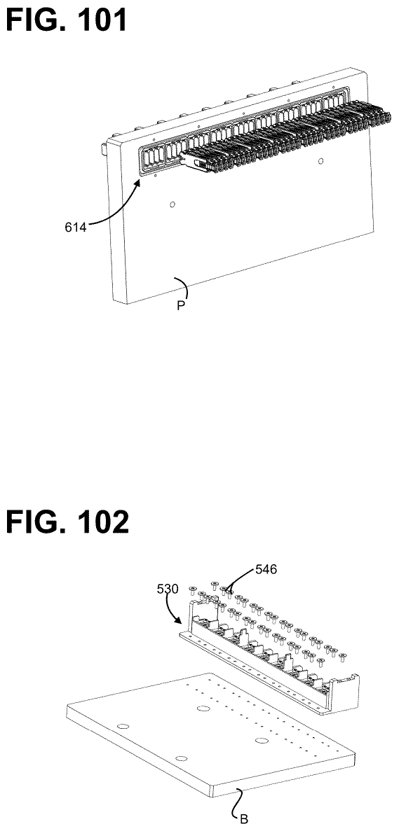

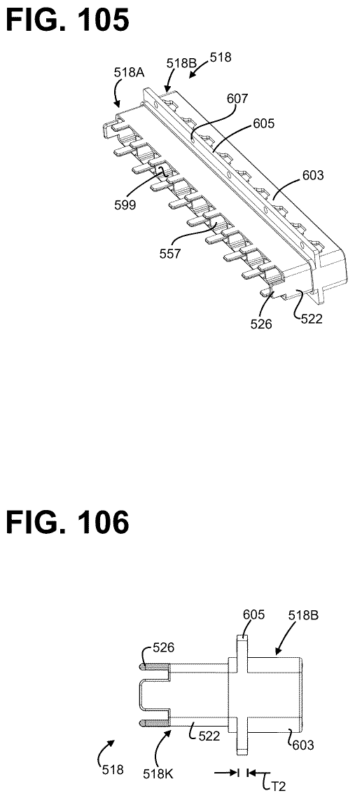

Referring to FIGS. 90-106, still another embodiment of a backplane connection system in accordance with the present disclosure is generally indicated at reference number 510. The backplane connection system 510 is similar to the backplane connection system 110, and corresponding parts are given the same reference numbers, plus 400. As in the preceding embodiments, the backplane connection system 510 comprises a backplane connector assembly 512 configured to be mounted on a module body B and a backplane adapter assembly 514 configured to be mounted on a panel P. Similar to the backplane connector assembly 112, the backplane connector assembly 512 comprises a multi-connector chassis 530 and a cover 534 that are configured to retain a plurality of push-pull fiber optic connectors 532 on a module body B. And similar to the backplane adapter assembly 114, the backplane adapter assembly 512 comprises a fiber optic adapters 516 received in an adapter collar 518 and defining a plurality of connector ports 520 for mating with the push-pull connectors 532 of the backplane connector assembly 512.

The backplane connection system 510 differs from the backplane connection systems 110, 210, 310, 410 described above in the number of connections it facilitates. The illustrated backplane connection system 510 has 36 push-pull fiber optic connectors 532 that collectively terminate 1152 fibers. The illustrated backplane connection system 510 also has nine quad adapters 516 defining 36 connector ports for the 36 adapters. It will be appreciated, that the number of fiber connections and number of connectors/connector ports can scale depending on the needs of a given network connection.

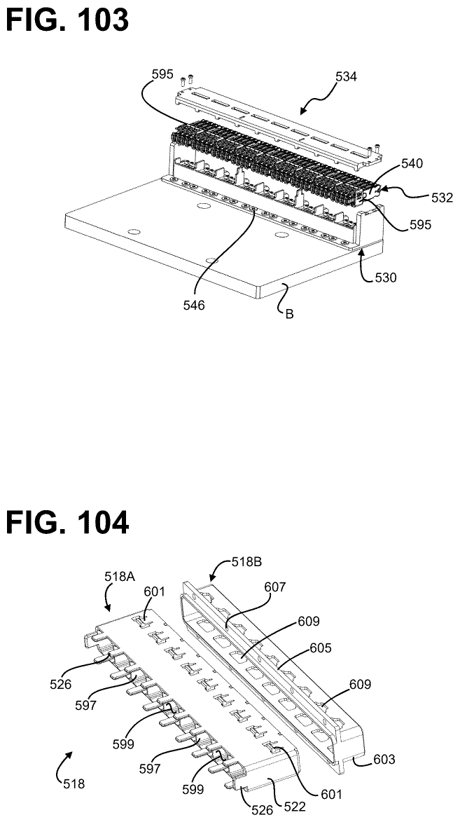

Referring to FIG. 103, the backplane connection system 510 also differs from the backplane connection systems 110, 210, 310, 410 described above in that it uses gang clips 595 in combination with the multi-connector chassis 530 and the cover 534 to retain and align the push-pull fiber optic connectors 532 in the backplane connector assembly 512. In the illustrated embodiment, each gang clip 595 gangs together four of the push-pull fiber optic connectors 532. The gang clips 595 directly engage the pullback extraction mechanisms 540, and the multi-connector chassis 530 and cover 534 engage the gang clips to facilitate simultaneous displacement of each of the pullback extraction mechanisms 540 with respect to the other portions of the push-pull fiber optic connectors.

Referring to FIGS. 104-106, the backplane connection system 510 further differs from the backplane connection systems 110, 210, 310, 410 described above in that the adapter collar 518 is a two-piece assembly comprising a main collar body 518A and a flange body 518B. The main collar body 518A comprises a rectangular shroud portion 522 and a plurality of cantilevered guide fingers 526 extending forward from the front end of the shroud portion. The interior of the shroud portion 522 is partitioned by partition walls 597 to define individual receptacles 599 for each of the fiber optic adapters 516. A set of latch elements 601 are formed on the top wall and the bottom wall of the shroud portion 522. The flange body 518B comprises a shroud portion 603 and a panel attachment flange 605 at a front end region of the shroud portion. The attachment flange 605 has a thickness T2 along the z-axis and includes a plurality of fastener openings 607. The shroud portion 603 includes a plurality of latch recesses 609 configured to latch with the latch elements 601 when the shroud portion 522 of the main collar body 518A is mated in the shroud portion 603 of the flange body 518B.

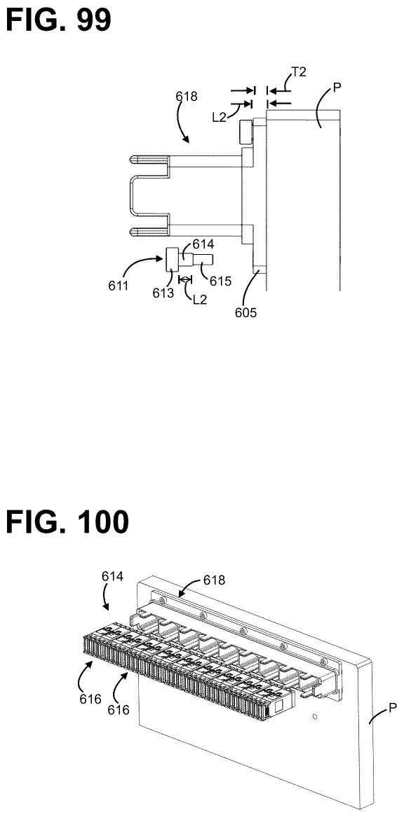

Referring to FIGS. 98-99 and 102-103, the backplane connection system 510 differs from the backplane connection systems 110, 210, 310, 410 described above in that the fasteners 546 fix the multi-connector chassis 530 in position on the module body B and the floating range of motion is instead provided by fasteners 611 that secure the backplane adapter assembly 514 to the panel P. Each fastener 611 comprises a head 613, a threaded shank portion 615, and a smooth bearing portion 614 between the head and the threaded shank portion. The threaded shank portion 615 is configured to be fastened to the panel P. The bearing portion 614 has a larger diameter than the threaded shank portion 615 so that the smooth bearing portion bottoms out on the front face of the panel P when the threaded shank portion is threaded into fastened relation with the panel. Each bearing portion 614 is configured to be received in a respective one of the fastener openings 607 of the flange 605. As shown in FIG. 99, each bearing portion 614 has a length L2 along the z-axis that is greater than the thickness T2 of the flange 605. As a result, when the fasteners 611 secure the backplane adapter assembly 614 to the panel P, the length L1 along the z-axis between the front face of the panel and the back face of the fastener head 614 is greater than the thickness T2 of the flange 605. This difference permits the backplane adapter assembly 614 to float relative to the panel P in a limited range of motion along the z-axis. In certain embodiments, the diameters of the fastener openings 607 could also be slightly larger than the diameters of the bearing portions 614 so that the backplane adapter assembly 614 can also float with respect to the panel P in a limited range of motion along the x-axis and/or y-axis.

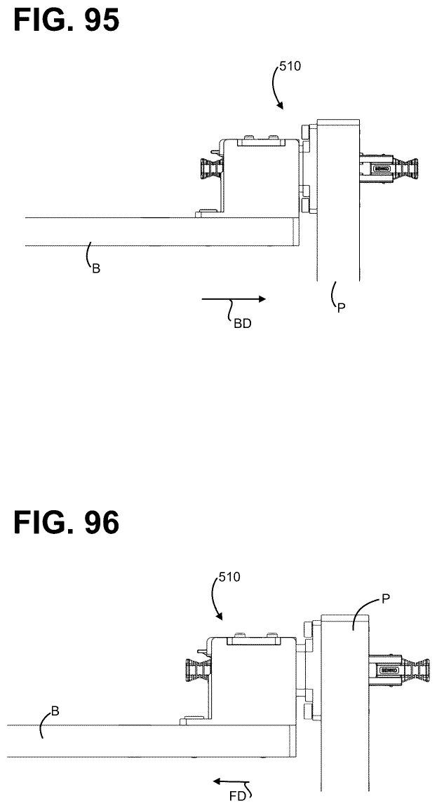

FIGS. 94 and 95 show a blind mating sequence of the backplane connection system 510. When the module body B is advanced in the insertion direction BD, the backplane connector assembly 512 will blind mate with the backplane adapter assembly 514. Any minor misalignment will self-correct during blind mating because the backplane adapter assembly 514 can move in a limited range of floating motion with respect to the panel P as the alignment features (e.g., the guide fingers 526) of the two mating backplane assemblies engage.

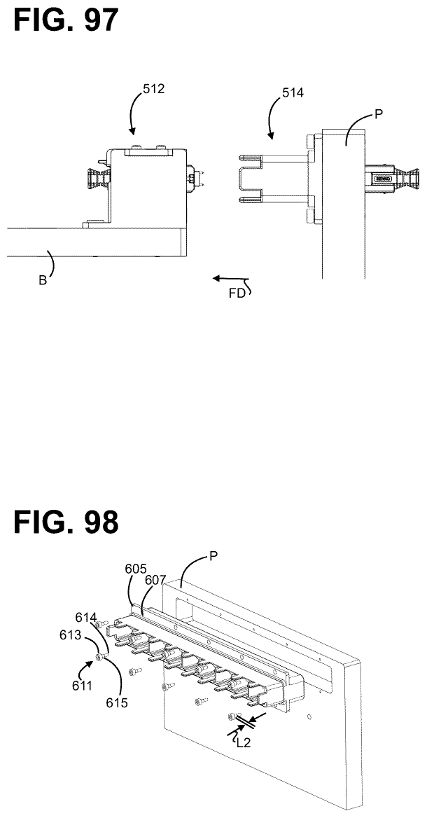

FIGS. 96 and 97 show an extraction sequence of the backplane connection system 510. The module body B is pulled in the extraction direction FD, which simultaneously actuates the pullback extraction mechanisms of each of the push-pull connectors 532 so that they are extracted from the connector ports 520.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A fiber optic backplane connection system comprising:
a backplane adapter assembly comprising a fiber optic adapter supported on a panel extending in a plane parallel to an x-axis and a y-axis of the fiber optic backplane connection system, the fiber optic adapter comprising a plurality of connector ports arranged in a row along the y-axis;
a backplane connector assembly comprising:
a multi-connector chassis mounted on a module body such that the multi-connector chassis moves substantially with the module body in relation to the panel and the backplane adapter assembly, the module body being movable in relation to panel and the backplane adapter assembly along a z-axis of the backplane connection system between a first position and a second position; and
a plurality of push-pull fiber optic connectors mounted on the multi-connector chassis, each of the push-pull fiber optic connectors configured to mate with one of the connector ports, the multi-connector chassis holding the push-pull fiber optic connectors on the module body such that the push-pull fiber optic connectors are all simultaneously blind mated with the connector ports of the fiber optic adapter by the module body moving backward from the first position and the second position;
wherein the fiber optic backplane connection system is configured to permit relative floating movement between the plurality of push-pull fiber optic connectors and the fiber optic adapter as the module body moves from the first position and the second position to simultaneously blind mate all the push-pull fiber optic connectors into the connector ports of the fiber optic adapter.

2. The fiber optic backplane connection system of claim 1, wherein the backplane connector assembly further comprises a fastener securing the multi-connector chassis to the module body such that the multi-connector chassis is configured for movement relative to the module body in a limited range of floating motion.

3. The fiber optic backplane connection system of claim 2, wherein the multi-connector chassis comprises a base having a top side, a bottom side and a thickness extending along the x-axis from the bottom side to the top side, the base defining a slot extending through the thickness of the base, the slot having a first end, a second end, and a length extending along the z-axis from the first end to the second end, the slot having a first side, a second side, and a width extending along the y-axis from the first side to the second side.

4. The fiber optic backplane connection system of claim 3, wherein the fastener is received in the slot such that the multi-connector chassis is configured for movement relative to the module base in a limited range of z-axis floating motion extending from a first terminal z-axis position in which the base abuts the fastener at the first end of the slot to a second terminal z-axis position in which the base abuts the fastener at the second end of the slot.

5. The fiber optic backplane connection system of claim 3, wherein the fastener is received in the slot such that the multi-connector chassis is configured for movement relative to the module base in a limited range of y-axis floating motion extending from a first terminal y-axis position in which the base abuts the fastener at the first side of the slot to a second terminal y-axis position in which the base abuts the fastener at the second side of the slot.

6. The fiber optic backplane connection system of claim 3, wherein the fastener the comprises a head above the base and a bearing portion loosely received in the slot and extending along the x-axis from the tip portion to the head such that the multi-connector chassis is configured for movement relative to the module base in a limited range of x-axis floating motion extending from a first terminal x-axis position in which the top side of the base is spaced apart from the head along the x-axis to a second terminal x-axis position in which the top side of the base abuts the head.

7. The fiber optic backplane connection system of claim 1, further comprising a fastener securing the backplane adapter assembly to the panel such that the backplane adapter assembly is configured for movement relative to the panel in a limited range of floating motion.

8. The fiber optic backplane connection system of claim 7, wherein the backplane adapter assembly comprises an adapter flange having and a thickness along the z-axis, the flange defining an opening extending through the thickness of the flange, wherein the fastener the comprises a shank portion secured to the panel, a head portion in front of the flange, and a bearing portion received in the opening so that the backplane adapter assembly is configured for movement relative to the panel in a limited range of z-axis floating motion.

9. The fiber optic backplane connection system of claim 1, further comprising a cover secured to the multi-connector chassis such that the multi-connector chassis and the cover define a receptacle in which the plurality of push-pull fiber optic connectors are received.

10. The fiber optic backplane connection system of claim 9, wherein the backplane adapter assembly further comprises an adapter collar secured to the panel and surrounding the fiber optic adapter.

11. The fiber optic backplane connection system of claim 10, wherein the adapter collar is configured to be received in the receptacle by the module body moving from the first position and the second position.

12. The fiber optic backplane connection system of claim 11, wherein the multi-connector chassis and/or cover defines a guide slot and the adapter collar comprises a cantilevered guide finger configured to be received in the guide slot by the module body moving from the first position and the second position.

13. The fiber optic backplane connection system of claim 9, wherein each push-pull fiber optic connector comprises a fiber optic ferrule, a ferrule holder, and a pullback extraction mechanism configured to be pulled backward in relation to the ferrule holder, wherein each push-pull fiber optic connector is configured to latch with the fiber optic adapter when the push-pull fiber optic connector is mated with the respective connector port, wherein the pullback extraction mechanism is configured to unlatch the push-pull fiber optic connector from the connector port, wherein the multi-connector chassis and/or the cover is/are configured to engage the pullback extraction mechanism of each of the push-pull fiber optic connectors such that the push-pull fiber optic connectors are all pulled backward in relation to the respective ferrule holders to unlatch all of the push-pull fiber optic connectors from the fiber optic adapter and extract all of the push-pull fiber optic connectors from the connector ports when the module body is moved forward from the second position to the first position.

14. The fiber optic backplane connection system of claim 1, wherein the plurality of push-pull fiber optic connector comprise 36 push-pull fiber optic connectors terminated 1152 fibers.

15. The fiber optic backplane connection system of claim 1, wherein the fiber optic adapter comprises a plurality of multiport adapters.

16. The fiber optic backplane connection system of claim 15, wherein the backplane assembly comprises and main collar body surrounding the multiport adapters and a flange body surrounding the adapter collar. 17 The fiber optic backplane connection system of claim 1, wherein the fiber optic adapter is a shuttered adapter.

18. The fiber optic backplane connection system of claim 1, wherein the push-pull connectors are one of SN, MPO, SN-MT, MU, SC, CS, MDC, and MMC connectors.

19. A backplane connector assembly for a fiber optic backplane connection system, the backplane connector assembly comprising:
a multi-connector chassis comprising a base configured to be fastened on a module body such that the multi-connector chassis moves substantially with the module body in relation to a panel and a backplane adapter assembly supported on the module body, the multi-connector chassis further comprising a cradle portion on the base, the cradle portion defining a plurality of connector retainers arranged in a line along a y-axis of the fiber optic backplane connection system, the cradle portion defining first and second end walls;
a plurality of push-pull fiber optic connectors mounted on the multi-connector chassis, each of the push-pull fiber optic connectors configured to mate with one of a plurality of connector ports of a fiber optic adapter of the backplane adapter assembly, each push-pull fiber optic connector comprising a fiber optic ferrule, a ferrule holder, and a pullback extraction mechanism configured to be pulled backward in relation to the ferrule holder, wherein each push-pull fiber optic connector is configured to latch with the fiber optic adapter when the push-pull fiber optic connector is mated with the respective connector port and wherein the pullback extraction mechanism is configured to unlatch the push-pull fiber optic connector from the connector port, each pullback extraction mechanism being retained in a respective one of the connector retainers such that the pullback extraction mechanisms are movable with the multi-connector chassis in relation to the ferrule holders such that the push-pull fiber optic connectors can all be simultaneously unlatched from the fiber optic adapter by pulling the multi-connector chassis backward; and
a cover supported on the first and second end walls and fastened to the multi-connector chassis to secure the plurality of push-pull fiber optic connectors in the cradle portion.

20. A backplane adapter assembly for a fiber optic backplane connection system, the backplane adapter assembly comprising:
a fiber optic adapter configured to be supported on a panel extending in a plane parallel to an x-axis and a y-axis of the fiber optic backplane connection system, the fiber optic adapter comprising a plurality of connector ports arranged in a row along the y-axis, each of the connector ports configured to mate with one of a plurality of push-pull fiber optic connectors of a backplane connector assembly; and
an adapter collar secured to the panel and surrounding the fiber optic adapter, the adapter collar configured to be received in a receptacle of the back plane connector assembly surrounding the plurality of push-pull fiber optic connectors, the adapter collar defining a plurality of cantilevered guide fingers protruding beyond the fiber optic adapter and configured to be received to guide the adapter collar into the receptacle and guide fiber optic adapter to mate with the push-pull fiber optic connectors.
